(19) United States
(12) Patent Application Publication
(10) Pub. No.: US 2012/0232925 A1
(43) Pub. Date: Sep. 13, 2012

(54) OFFERING DRUG SAMPLES THROUGH ELECTRONIC MEDICAL RECORDS

(75) Inventors: Tom Quinn, Orchard Park, NY (US); Tom Miller, Seattle, WA (US); Cecil Kost, Santa Clarita, CA (US); Sanjay Pingle, Seattle, WA (US)

(73) Assignee: Skyscape.com, Inc., Marlborough, MA (US)

(21) Appl. No.: 13/294,805

(22) Filed: Nov. 11, 2011

Related U.S. Application Data
(63) Continuation-in-part of application No. 10/674,904, filed on Sep. 30, 2003, now Pat. No. 8,082,173.
(60) Provisional application No. 60/472,956, filed on May 22, 2003.

(51) Int. Cl. G06Q 30/02; G06Q 50/24

(52) U.S. Cl. 705/3

(57) ABSTRACT

A facility fulfills drug samples to prescribers in several different manners. A prescriber can request drug samples through an electronic medical record application, an electronic prescribing application, or a mobile application, which are sent to or printed for patients who in turn go to a pharmacy to obtain the free medications.

### CROSS-REFERENCES TO RELATED APPLICATIONS

This application is a continuation-in-part of patent application Ser. No. 10/674,904, filed Sep. 30, 2003, which claims the benefit of Provisional Application No. 60/472,956, filed May 22, 2003, both of which are incorporated herein by reference.

### FIELD OF THE INVENTION

The present invention relates generally to an architecture for distributing drug samples, and more particularly, to the design of software relating to drug sample fulfillment incorporating protocols and means for expansion and interfacing with other systems.

### BACKGROUND

From idea to production, the development of a new drug can take up to 10 years and cost about $800 million. But many risks abound in the development process that can cause complete failure. The process usually starts with the idea that an existing chemical substance has therapeutic value or that the structure of an existing drug can be modified for new clinical uses. Out of 10,000 chemicals tested in a laboratory, only one may eventually become a drug. Besides the expense necessary to produce them, drugs are heavily regulated by the bureaucracy of government agencies. In the United States, the FDA not only approves new drugs, but also determines how drugs are produced and sold by continually monitoring the development and use of all drugs sold. This is the backdrop against which a pharmaceutical company (“pharma 102”) markets its precious few developed drugs 104. See FIG. 1.

Traditionally, a sales representative 106 of the pharma 102 visits one or more prescribers 110, leaves behind some drug samples of the drugs 104, and waits in trust that the prescribers 110 will prescribe these drug samples to their patients. When a sales representative 106 visits a prescriber, such as one of the prescribers 110, the sales representative 106 is performing two actions together called a drug detail. First, the sales representative 106 educates the prescriber about the efficacy of the drug samples for various disease states and differentiates them from any competitive drugs in the marketplace. Second, the sales representative 106 leaves drug samples behind with the prescriber so that he can dispense these drug samples to his patients.

A triangle 108 hierarchically organizes all prescribers into deciles, which are numbers that divide a frequency distribution (the regularity of which a prescriber prescribes drugs) into 10 classes such that each contains the same number of prescribers. The upper 1-3 deciles describe one or more prescribers 110. The remaining 4-10 deciles describe one or more prescribers 112. Prescribers at deciles 1-3 comprise 25 percent of all prescribers and generate 50 percent of all prescriptions. The remaining 75 percent of prescribers are at deciles 4-10 and prescribe the remaining 50 percent of all other prescriptions. Because individual prescribers at deciles 4-10 do not generate as much income for the pharma 102 compared to those in the top three deciles, the sales representative 106 typically does not visit these prescribers, but instead, focuses her efforts on prescribers 110 at deciles 1-3.

The reason for this is mainly economic. For each sales representative 106, the pharma 102 incurs numerous expenses including purchasing and maintaining an automobile for the sales representative 106 to travel to the prescribers, and paying a salary, benefits, and so on. Also a growing number of billions of dollars are spent each year on everything necessary to support the distribution of drug samples, such as packaging and delivery. When this cost is multiplied by the cost of employing multiple sales representatives, the pharma 102 cannot afford to visit all prescribers to solicit patronage of its drugs.

But there are still other reasons beyond the economic ones that prevent the sales representative 106 from visiting all prescribers. One or more prescribers 112 may be located in remote areas making it difficult for the sales representative 106 to reach them. Certain prescribers 112 do not wish to see a sales representative 106 because they are too busy with their practice or they belong to an organization, such as a hospital, that forbids sales representatives from soliciting prescribers on its premises. Another reason why most prescribers 112 are not visited by the sales representative 106 has to do with absences by the sales representative 106 because of parental leaves, military duties, firings, layoffs, or unexpectedly resignations, and so on.

While it is cost prohibitive for the pharma 102 to send sales representatives to visit all prescribers, prescribers who know about the drug samples and want access to drug samples have problems too. If the prescriber were to be interested in designing a therapy from five different brands of drugs, he might have to track down five different sales representatives to get the drug samples. The prescriber's preferences are completely ignored. The biggest dissatisfaction of all among prescribers, however, is the lack or inconsistent supply of physical samples in their hands. These prescribers may not have easy access to the sales representative 106. And even if access were possible, the sales representative 106 may not have a ready supply of physical samples for these prescribers to use. The literature has shown that if a prescriber is dissatisfied with a drug brand due to lack of physical samples, the prescriber will not prescribe that particular drug brand to patients.

When the sales representative 106 leaves drug samples with the prescriber, the prescriber signs an acknowledgment indicating that these drug samples are now in his possession. Beyond that, however, there is no data that tracks whether drug samples actually get prescribed to patients of the prescriber. No additional information is possible beyond the point at which drug samples are given to the prescriber. So even though the pharma 102 has spent a great deal of money on drug samples, it has no means of knowing whether the physical samples were actually prescribed to patients or tossed uselessly into a garbage can. Without a way to track these drug samples, the pharma 102 cannot improve its drug sample distribution. Moreover, without tracking, expired drug samples may be prescribed to patients, diminishing their efficacy. This may add to wrongful impressions by patients regarding the drug's effectiveness and eventually will lead to a lack of acceptance of the drug in the marketplace.

In sum, not only is it expensive and laborious to develop new drugs, but the traditional drug sample distribution process does not allow the pharma 102 to assess the effectiveness of its drug sample fulfillment program further increasing financial risk to the pharma 102. Not all prescribers can be reached by the sales representative 106, hence limiting the distribution of drug samples to patients who may benefit from them. On the other hand, prescribers who do wish to have an opportunity to try the drug samples cannot obtain a consistent supply. Thus, there is a need for an architecture for enhancing drug sample fulfillment distribution while avoiding or reducing the foregoing and other problems.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In accordance with one aspect of the subject matter, a system form includes a system for electronically distributing drug samples, which comprises a piece of software implementing an electronic medical record application. The system further comprises a drug sample fulfillment platform for providing a list of drug samples from pharmaceutical companies through the electronic medical record application to allow a prescriber to prescribe a drug sample to a patient. The time frame, dosages and quantity of drug samples are different for different prescribers or different patients depending on brand rules of the pharmaceutical companies. The drug samples include electronic samples, electronic vouchers, or electronic coupons. Instead of the electronic medical record, the piece of software is configured to implement an electronic prescribing application or a mobile application.

In accordance with another aspect, a method form includes a method for electronically distributing drug samples, which comprises receiving a drug sample selection from an electronic medical record application. The method further comprises providing a list of drug samples from pharmaceutical companies through the electronic medical record application to allow a prescriber to prescribe a drug sample to a patient.

The time frame, dosages and quantity of drug samples are different for different prescribers or different patients depending on brand rules of the pharmaceutical companies.

In accordance with a further aspect, a computer-readable form includes a computer-readable medium having computer-executable instructions stored thereon for implementing a method for electronically distributing drug samples, which comprises receiving a drug sample selection from an electronic medical record application. The method further comprises providing a list of drug samples from pharmaceutical companies through the electronic medical record application to allow a prescriber to prescribe a drug sample to a patient. The time frame, dosages and quantity of drug samples are different for different prescribers or different patients depending on brand rules of the pharmaceutical companies.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram illustrating a conventional system showing various problems of distributing drug samples to prescribers;

FIG. 2A is a block diagram illustrating an exemplary drug sampling fulfillment architecture;

FIG. 2B is a block diagram illustrating pieces of a system for drug sample fulfillment distribution, according to one embodiment of the present invention;

FIG. 2C is a block diagram illustrating pieces of a system for drug sample fulfillment distribution, according to one embodiment of the present invention;

FIG. 3A is a pictorial diagram illustrating various Web pages associated with the drug sample fulfillment platform, according to one embodiment of the present invention;

FIG. 3B is a pictorial diagram illustrating various Web pages of a drug sample fulfillment distribution platform, according to one embodiment of the present invention;

FIGS. 4A-4J are process diagrams illustrating a method for enhancing a drug sample fulfillment program, according to one embodiment of the present invention;

FIG. 5 is a block diagram illustrating an archetypical drug sampling fulfillment platform in cooperative interaction with an electronic medical record application, an electronic prescribing application, and a mobile application;

FIG. 6 is a block diagram illustrating an archetypical drug sampling fulfillment platform in one embodiment of the present subject matter; and

FIGS. 7A-7J are process diagrams illustrating an archetypical method for presenting drug sample offers from a drug sample fulfillment platform to an electronic medical record application, an electronic prescribing application, and a mobile application.

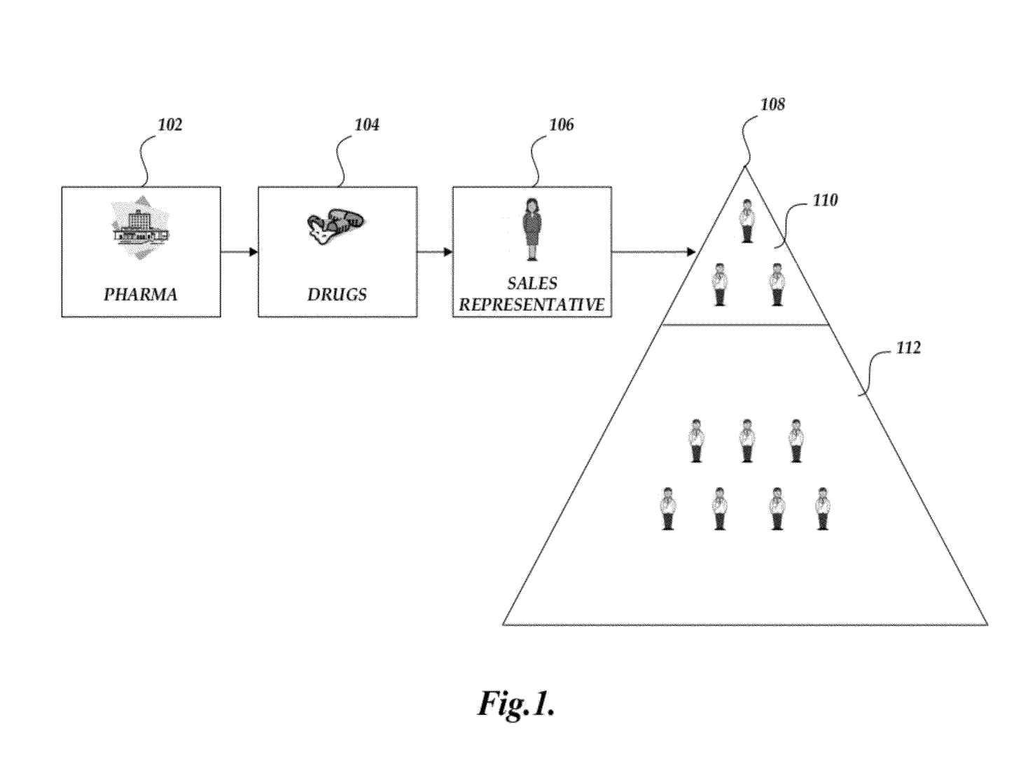

### DETAILED DESCRIPTION

A system in which drug samples 212 are distributed to one or more prescribers 210 without the need to employ sales representatives is illustrated. A pharma 202 is a company engaged in the manufacture and sale of pharmaceuticals, which are medicinal drugs used for therapeutic applications. The term “prescribers” as referred to herein includes, but is not limited to, physicians; physician assistants; certified registered nurse practitioners; advanced registered nurse practitioners; and other licensed professionals authorized to prescribe medications.

Throughout a series of stages through which a drug passes during its lifetime, starting with its launch, continuing with its maturation in the marketplace, and concluding with the end of its patent life cycle, a brand manager 204 is assigned by the pharma 202 to manage the drug sample distribution to prescribers 210. The brand manager 204 begins a drug sample distribution program by first identifying a group of prescribers 210. The brand manager 204 selects these prescribers 210 by excluding or including each prescriber based on criteria defined by the brand manager 204 (e.g., medical practice specialty, therapeutic class to which drug samples belong, prescribing volume and behavior). Prescribers 210 can also be selected via their Drug Enforcement Agency (DEA) number or individually by the brand manager 204. The DEA number is a unique global identifier that identifies a particular prescriber who prescribes drugs in the United States.

After the brand manager 204 has selected a group of prescribers 210, the brand manager 204 produces a set of brand rules 206 which define the availability of drug samples to each of the prescribers 210. The set of brand rules 206 may cause one prescriber's drug sample availability and characteristics to be different from those of another prescriber. Thus, for each prescriber there is a virtual drug sample cabinet tailored specifically for that prescriber. Preferably, the group of prescribers 210 is divided into segments. The brand rules provide personalization and customization for each segment. Many other personalization capabilities to tailor the distribution of drug samples to prescribers 210 are possible, such as various delivery methods; various drug strengths; trademark and local presentation of drug samples; customized drug disclaimers; specific product, package, and brand Web sites; and facilitating the scheduling of prescriber interactions with sales representatives or medical science liaisons.

The set of brand rules 206 are used to focus the drug sample fulfillment platform 208 to distribute drug samples to prescribers 210. The drug sample fulfillment platform 208 is preferably a Web-based platform that enables registered health care professionals, pharma 202's sales representatives, and other authorized users to order drug samples and obtain related drug information via the Internet. The drug sample fulfillment platform 208 is also preferably electronically linked to one or more prescriber-oriented online portals (such as Web MD), an e-Detailing service (such as Lathian's MyDrugRep.com), or to a prescriber's practice management software running on a computer system in the prescriber's office.

The drug sample fulfillment platform 208 is tailored based on the brand rules 206 established by the brand manager 204 for each drug and prescriber segment. Using the drug sample fulfillment platform 208, the brand manager 204 can select which prescribers are authorized to use the drug sample fulfillment platform 208 and the services provided thereon, the forms of drug samples they can access, and the drug sample quantity and delivery method. The drug sample fulfillment platform 208 can be configured to allow a prescriber to request a physical sample drop shipment. Requests for such physical samples are electronically communicated (including facsimile communications) to the brand manager 204's designated fulfillment vendors that pick, pack, and ship physical samples to the requesting prescriber's office. Using this method, prescribers 210 no longer need to rely on sales representatives to deliver physical samples. As an alternative to physical samples, the prescribers 210 use the drug sample fulfillment platform 208 to obtain pre-printed vouchers. These vouchers, when accompanied by a prescription, can be redeemed at a pharmacy 215 by patients 214 for free trial medication. The drug sample fulfillment platform 208 can be configured to allow prescribers 210 to request a drop shipment of pre-printed drug vouchers. If the brand rules 206 allow, prescribers 210 may print on demand coupons from the drug sample fulfillment platform 208. These on-line, on-demand print coupons are printed real-time in the prescriber's office. The prescriber signs the printed coupon as a prescription or attaches the voucher to a prescription for the patients 214 to redeem at the pharmacy 215 to obtain free drug sample medication. One advantage of both types of vouchers is that they ensure that the drug samples distributed to patients 214 are fresh, with their efficacy not diminished by expiration.

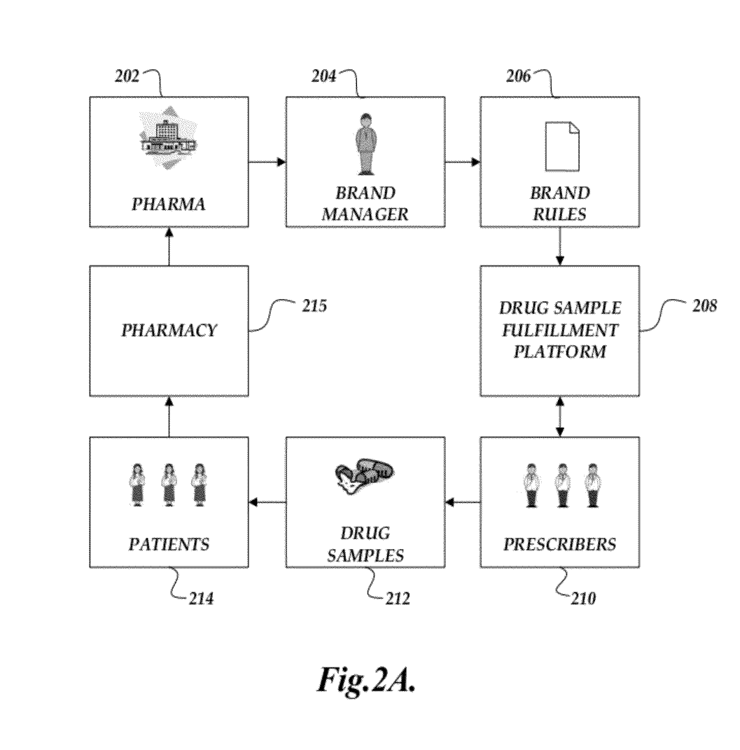

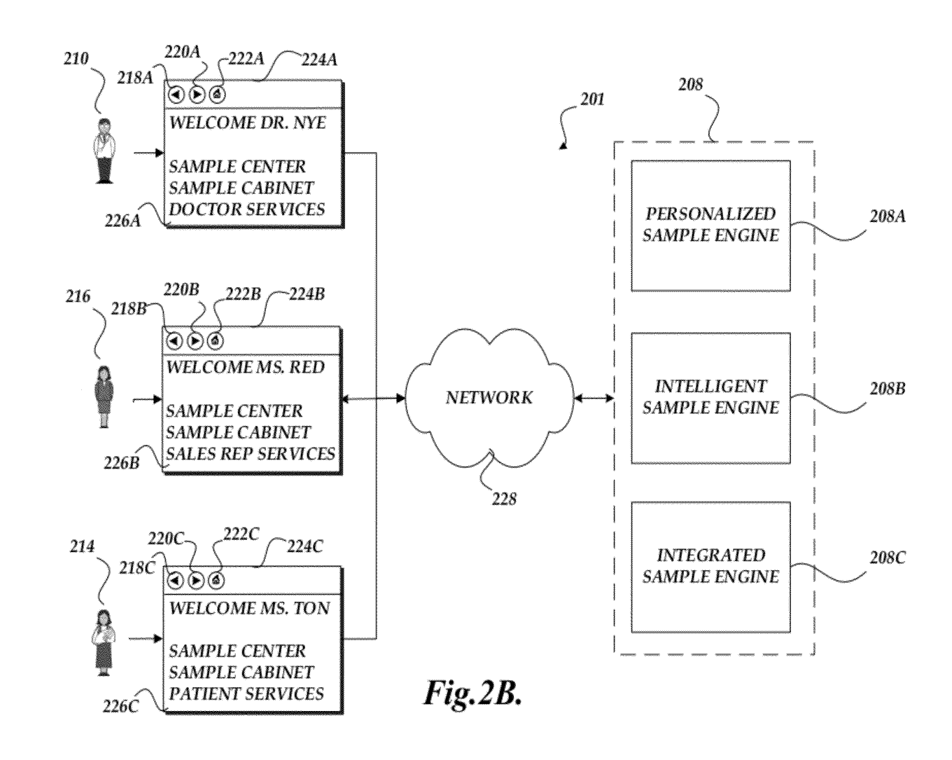

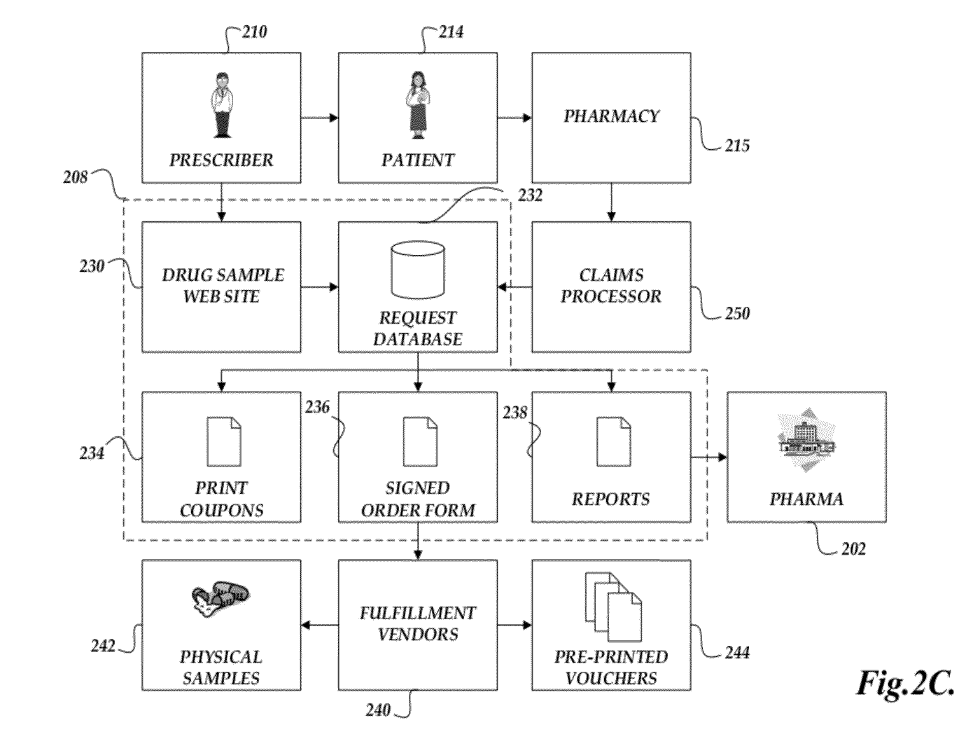

FIG. 2B illustrates a system in which a prescriber 210, a sales representative 216, and a patient 214 interact with the drug sample fulfillment platform 208. This system is a networked computing environment that has pieces of hardware and software applications. The prescriber 210, the sales representative 216, and the patient 214 interact with the resources of the networked computing environment 200 via personal computers (not shown). A number of Web browsers 224A-224C run on personal computers. These Web browsers are software that let the prescriber 210, the sales representative 216, and the patient 214 view HTML documents and access files and software related to those documents on the drug sample fulfillment platform 208. Web browsers 224A-224C include a number of tools for navigation, such as BACK buttons 218A-218C; FORWARD buttons 220A-220C. These buttons are positions on navigation bars allowing easy access to Web pages by the prescriber 210, the sales representative 216, and the patient 214.

Web pages 226A-226C are each a starting point to a Web site that serves as a gateway to a collection of links, content, and services designed to guide the prescriber 210, the sales representative 216, and the patient 214 to information they are likely to find interesting that relates to drug samples and their distribution. Web pages 226A-226C include greetings that identify a particular user of the drug sample fulfillment platform 208, such as “WELCOME DR. NYE” for the prescriber 210; “WELCOME MS. RED” for the sales representative 216; and “WELCOME MS. TON” for the patient 214. Web pages 226A-226C include a hyperlink (SAMPLE CENTER), that allows access to available drug samples personalized to the particular user, and another hyperlink (SAMPLE CABINET), that allows access to the drug sample ordering history of the particular user. Hyperlinks “DOCTOR SERVICES,” “SALES REP SERVICES,” and “PATIENT SERVICES” of Web pages 226A-226C allow the prescriber 210, the sales representative 216, and the patient 214 to access drug information, answers to frequently asked questions, profile updates, and online drug sample information. Web pages 226A-226C and pieces of content on these Web pages are made available by the drug sample fulfillment platform 208 via a network 228. The network 228 is a group of computers and associated devices that are connected by communication facilities, such as the Internet.

The drug sample fulfillment platform 208 is one or more computers or one or more programs executing on one or more computers that respond to requests of a user, such as the prescriber 210, the sales representative 216, or the patient 214, to download Web pages 226A-226C and pieces of content associated with Web pages 226A-226C. In one embodiment, Web pages 226A-226C are preferably available as a response to an application specific messaging protocol. Web pages 226A-226B, as a response to an application specific messaging protocol, mate with a Web portal when the prescriber 210, the sales representative 216, or the patient 214 use the Web portal. The drug sample fulfillment platform 208 can push a message, such as via e-mail or a pop-up message, to the prescriber 210, when it notices that the prescriber 210 has not ordered a drug sample for a certain amount of time. Depending on the prescriber's order history, his specialty, etc., the message may be pushed to help remind the prescriber about the availability of drug samples.

In one embodiment, the drug sample fulfillment platform 208 comprises two engines, a pharma rules sample engine 208A (encompassing personalization and intelligent brand rule implementation), and a marketing sample engine 208C (encompassing integration with drug sample suppliers and Web portals). The pharma rules sample engine 208A tailors the distribution of drug samples to one or more prescribers 210, one or more sales representatives 216, and one or more patients 214. The pharma rules sample engine 208A monitors the distribution of drug samples to a particular user, such as the prescriber 210. If the prescriber 210 does not respond to the tailored drug sample allocation as specified by the pharma rules engine 208A, the pharma rules engine 208A modifies the allocation of drug samples to the prescriber 210 so that the prescriber 210 responds more favorably, such as by prescribing to his patients the distributed drug samples. If the prescriber 210 does not respond at all, the pharma rules sample engine 208A reduces or eliminates the allocation of drug samples to the prescriber 210. The marketing sample engine 208C links or integrates the supply of drug samples and parties who are interested in drug samples, such as the prescriber 210, the sales representative 216, or the patient 214. The combination of the two engines reduces or solves the problem of the lack or inconsistent supply of drug samples available for interested parties to prescribe or use.

Various embodiments of the present invention allow the sales representative 216 to access the drug sample fulfillment platform 208 to order physical samples or pre-printed vouchers to be shipped to the sales representative 216 for distribution. The sales representative 216 may have limited capacity to distribute many physical samples or massive amounts of pre-printed coupons. Instead, the sales representative 216 can access the drug sample fulfillment platform 208 to print a desired number of coupons to give to the prescriber 210. In one embodiment, to access the drug sample fulfillment platform 208, the sales representative 216 authenticates that she has the proper access by providing a territorial identifier in which she operates and her last name, among other pieces of information. Preferably, the number of coupons that the sales representative 216 can print in any one log-in session is limited to a certain quantity, as specified by the brand rules 206.

The drug sample fulfillment platform 208 can also serve as an avenue for consumers, such as the patients 214, to learn about available drugs and request samples. Consumers can access the Web site and print vouchers for brand manager 204-approved drugs to take to their individual physician for signature or authorization. Thereby, consumers could be categorized as either: general consumer-individuals having public web access to a “general sample medicine cabinet”; or patient consumer-individuals with privileged access to a custom formulary program due to their health plan affiliation.

FIG. 2C illustrates another embodiment of the drug sample fulfillment platform 208. The prescriber 210 accesses a drug sample Web site 230 preferably via a Web portal. By selecting a link on the Web portal, the prescriber 210 generates a transaction that includes at least two pieces of information: a prescriber identifier and a partner identifier. The prescriber identifier uniquely identifies the prescriber 210 whereas the partner identifier identifies the Web portal from which the prescriber 210 selects the link to connect to the drug sample Web site 230. The drug sample Web site 230 produces Web pages that conform to the look and feel of the Web portal with the particular partner identifier. The prescriber identifier will be used by the drug sample Web site 230 to consult with the request database 232 to determine whether the prescriber 210 has visited the drug sample Web site 230 before. If the prescriber identifier is not stored in the request database 232, then it is the prescriber 210's first visit to the drug sample Web site 230. The drug sample Web site 230 will cause the prescriber 210 to undergo a registration process. Among other information, the drug sample Web site 230 asks the prescriber 210 for his name, his individual DEA number, his work address, his medical state license number, his specialty, his e-mail address, his phone, his fax number, and whether the prescriber 210 desires to have his name forwarded to a partner Web site that may provide further drug information, among other pieces of information. The prescriber 210 need not provide all of these pieces of information, because the drug sample Web site 230 can communicate with the prescriber-oriented Web portal to pull various pieces of information already associated with the prescriber 210. This registration process is preferably run only once for a particular prescriber 210.

Once the prescriber 210 has registered with the drug sample Web site 230, the drug sample Web site 230 will generate a personalized list of drug samples that are available to the prescriber 210 to obtain. In terms of services that can be provided to prescribers in addition to requesting drug samples, prescribers can be provided with information with respect to drugs, continuing medical education, peer forums and conferences, and access to reports on adverse drug reactions from the Web sites of pharmaceutical companies, and from the FDA. Upon exiting the drug sample Web site 230, the prescriber 210 is returned to the Web page of the Web portal from which the prescriber 210 linked to the drug sample Web site 230. During registration, the prescriber 210 is asked to select whether he is interested in receiving future drug samples (via a therapeutic class interest survey) to treat an existing or a new therapeutic class. If he elects to receive future drug samples, when these drug samples become available the prescriber 210 will be notified when the prescriber 210 returns to the drug sample Web site 230.

The prescriber 210, depending on the brand rules 206 specified by the brand manager 204, can access a combination of three sample forms including physical samples 242, pre-printed vouchers 244, and print coupons 234. The physical samples 242 are drug samples that are pre-packaged by the pharma 202 and shipped by a single brand manager-designated fulfillment vendor 240. The prescriber 210 can also order pre-printed vouchers 244, which are pre-printed pads of coupons. These coupons are picked, packed, and shipped to the prescriber 210 via the fulfillment vendors 240 (which may or may not be the same vendor which distributes physical samples). The print coupons 234 are those coupons that prescriber 210 prints in his office. The prescriber 210 can then sign the coupon and give the signed coupon to the patient 214.

To obtain either physical samples 242 or pre-printed vouchers 244, the prescriber 210 prints an order form from the drug sample Web site 230 via the request database 232, signs the order form, and faxes it to one or more fulfillment vendors 240. The pharma 202 can specify a fulfillment vendor 240 (whose fax number is printed on the order form) to which the prescriber 210 faxes the signed order form to obtain physical samples 242 and/or of pre-printed vouchers 244 as applicable. The order form 236 is first presented electronically to the prescriber 210 for the prescriber 210 to specify different drug samples that he is interested in. The order form 236 is also personalized to a particular prescriber 210 and a particular fulfillment vendor 240 in accordance with brand rules 206.

The drug sample fulfillment platform 208 is designed to work with any contracted prescriber-oriented Web portal which the prescriber 210 may use and any fulfillment vendor 240 that the pharma 202 wishes to work with via an application specific messaging protocol. The prescriber 210 may order drug samples that may have to be fulfilled by two fulfillment vendors 240. The drug sample Web site 230 manages such a situation by printing one order form to be faxed to a particular fulfillment vendor and another order form to be faxed to a second fulfillment vendor. The drug sample fulfillment platform 208 removes the complexity of ordering drug samples for the prescriber 210 while reducing or eliminating mistakes (e.g., errors due to unreadable handwriting). Even if the signed order form 236 is somehow misplaced or lost, the prescriber 210 can print it out again (via the history reprint function) from the drug sample Web site 230 and fax the signed order form to the fulfillment vendors 240 to obtain the desired drug samples.

Upon receiving physical samples 342, pre-printed vouchers 244, or print coupons 234, the prescriber 210 can provide a combination of those sample forms to the patient 214 to redeem for free medications at the pharmacy 215. When the patient 214 comes to the pharmacy 215 to redeem sample forms for drug samples, the pharmacy 215 forwards the claim to a claims processor 250. The claims processor 250 decides whether to approve the claim. If the claim is approved, the pharmacy 215 provides the desired drug samples to the patient 214 free of charge.

The request database 232 stores for each prescriber 210 identification and the quantity of drug samples that were ordered. The drugs and quantity ordered is compared with the allocation limits for a particular prescriber. This can be presented to the prescriber 210 via the drug sample Web site 230 so that the prescriber 210 knows how many more drug samples the prescriber 210 can order. These pieces of information, among others, are stored by the request database 232. The information in the database can be correlated when the patient 214 takes a pre-printed voucher 244 or a print coupon 234 and redeems it at the pharmacy 215. These pieces of information can be analyzed and explained to the pharma 202 via one or more reports 238. For example, suppose a print coupon was redeemed on a particular date by the patient 214. The reports 238 can indicate when the coupon was redeemed by the patient 214. Moreover, the reports 238 can show whether there is a correlation between a drug sample fulfillment distribution program as specified by the brand rules 306 and the prescribing trend of the prescriber 210.

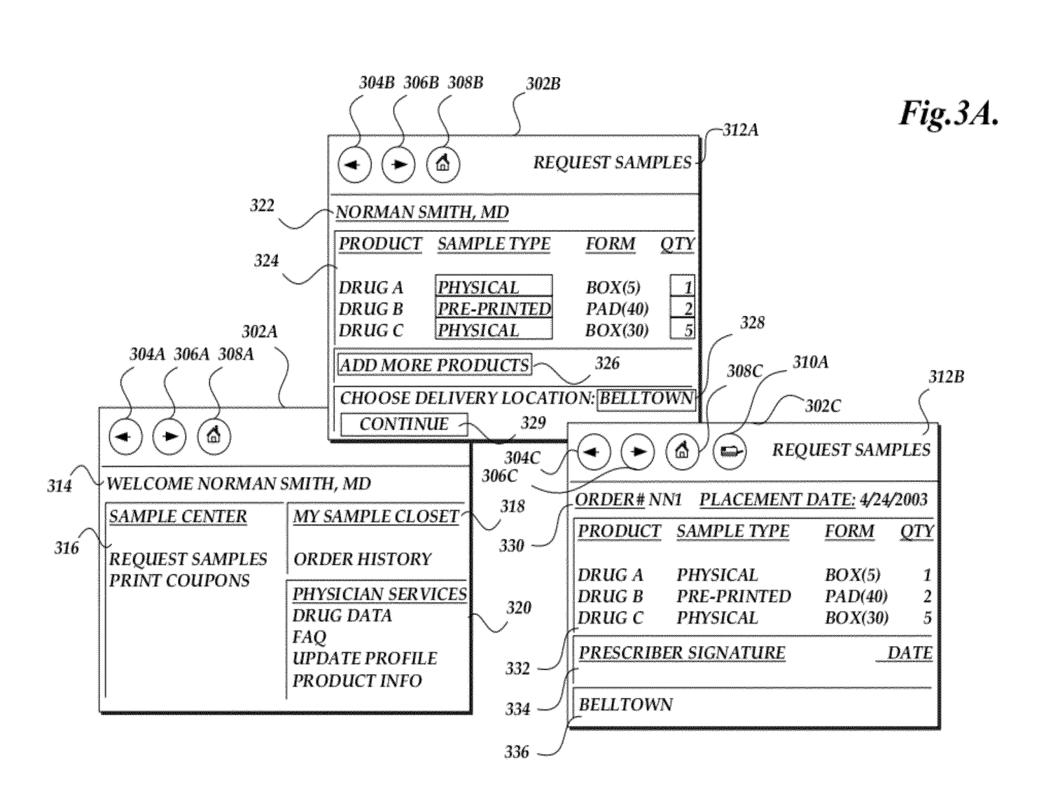

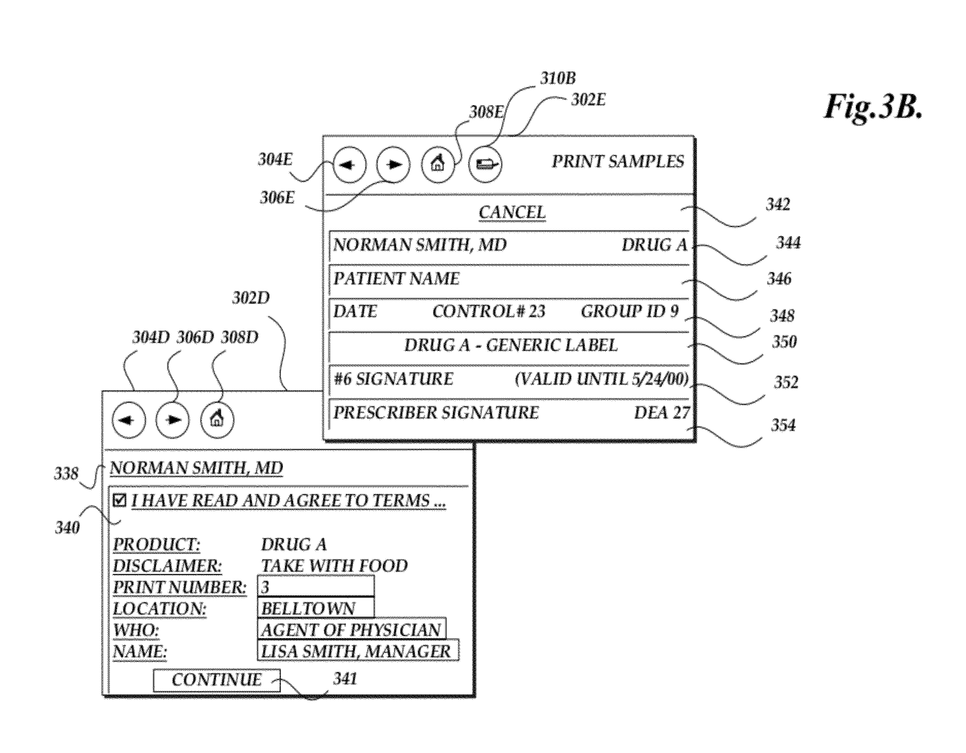

Various exemplary Web pages comprising the drug sample Web site 230 are illustrated at FIG. 3A and FIG. 3B. Web pages 302A-302E are navigated by a set of application built navigational buttons/links/tabs, such as PREVIOUS/CANCEL buttons 304A-304E, NEXT/CONTINUE/CONFIRM buttons 306A-306F, and HOME buttons 308A-308F. These buttons appear in standard locations on Web pages 302A-302E throughout the application. Regarding the Web page 302A, a greeting 314 “WELCOME NORMAN SMITH, M.D.” identifies the prescriber 210. A set of “SAMPLE CENTER” links 316 allows the prescriber 210 to access various sample services, such as “REQUEST SAMPLES” and “PRINT COUPONS.” A set of “MY SAMPLE CLOSET” links 318 allows the prescriber 210 to review his order history. A set of “PHYSICIAN SERVICES” links 320 allows the prescriber 210 to access drug data, get answers to frequently asked questions, update his profile, request additional detail support or product information from pharma sales representatives 106, obtain product information online, and therapeutic class survey. A further service available through various embodiments of the present invention includes maintaining “MY SAMPLE CLOSET” for a prescriber. Particular drug products and quantities can be suggested to the prescriber, and then the sample drug closet can be automatically replenished as requested by the prescriber. Also, for sample programs that expire, the system can shut down redemptions through the pharmacy network via the claims processor 250, notify all participating prescribers, and disable all online sample order requests for the specific drug.

Selecting the “REQUEST SAMPLES” link of the set of links 316 brings up an exemplary Web page 302B for the prescriber 210 to request drug samples. A title of the Web page “REQUEST SAMPLES” 312A appears on the menu bar and is flushed to the left for both the Web page 302B as well as the Web page 302C. Regarding the Web page 302B, line 322 identifies the name of the prescriber 210. Area 324 is an array formed from four columns and a number of rows. The first column identifies the product or the drug sample available to the prescriber 210. The second column is the sample type for a particular drug that the prescriber 210 can order. The third column identifies the form in which the drug sample is made available. The fourth column identifies the quantity that the prescriber 210 specifies. The first row of the area 324 indicates that “DRUG A” is available in physical form (or in an alternative form such as pre-printed vouchers) for which there are five samples in a box and that the prescriber 210 has ordered a quantity of one. The second column specifies that the “DRUG B” is available via pre-printed forms (or in an alternative form such as physical samples) for which 40 coupons are available in a pad and that the prescriber 210 has ordered a quantity of two. The third column specifies that drug C is available in physical form (or in an alternative form such as pre-printed vouchers) for which there are 30 samples in a box and that the prescriber 210 has ordered a quantity of five.

The prescriber 210 may select a button 326 “ADD MORE PRODUCTS” to add more drug samples to be ordered. The prescriber 210 also specifies a delivery location at line 328 for which “BELLTOWN” has been selected (other delivery destinations may be possible). When the prescriber 210 is satisfied with the order, he selects a CONTINUE button 329 to prepare a finalized order form for printing, which is presented by the Web page 302C. A PRINT button 310A is available for the prescriber 210 to select to print the finalized order form. Line 330 indicates an order number “NN1” and a placement date “Apr. 24, 2003,” among other pieces of information. An area 332 is a recap of the area 324 which shows the various drug samples that the prescriber 210 is interested in and the quantity of each that the prescriber 210 is expecting to receive. Area 334B requires the prescriber's signature as well as an execution date of the order form. Area 336 indicates the delivery address to which the samples will be shipped when the order form has been processed by fulfillment vendors 340.

If the prescriber 210 selects the “PRINT COUPONS” link in area 316 of the Web page 302A, the Web page 302D appears. Line 338 identifies the name of the prescriber 210, which is “NORMAN SMITH, M.D.” An area 340 includes a link “I HAVE READ AND AGREE TO TERMS . . . ” which allows the prescriber 210 to select and review terms and conditions for printing coupons for certain drug samples. The prescriber must check the box indicating his agreement with the PDMA (Prescription Drug Marketing Act which is a federal regulation prohibiting among other things the copying and/or selling of drug sample vouchers or coupons) guidelines before being allowed to print. The area 340 includes a “PRODUCT” line identifying the drug (DRUG A) for which the prescriber 210 may print coupons. An “Important Information” line specifies important information that the prescriber 210 can review in connection with the selected drug sample. An “INTENT TO PRINT NUMBER” line specifies the number of coupons which the prescriber 210 wishes to print. A “LOCATION” line allows the prescriber 210 to specify the prescriber's address that will be printed on the voucher. A “WHO” line allows the prescriber 210 to specify whether the prescriber 210 is a physician or an agent of the physician. A “NAME” line allows the person printing the coupons to specifically identify herself if she is an agent of the prescriber. Selecting a CONTINUE button 341 brings forth the Web page 302E for the prescriber 210 to review. Selecting a CANCEL button 343 terminates the session.

The content of the Web page 302E is in essence a coupon for the prescriber 210 to dispense to the patient 214. A PRINT button 310B allows the prescriber 210 to select and print out one or more coupons as specified on the Web page 302D. Line 342 allows the prescriber 210 to cancel the printing process. Line 344 identifies the names of the prescriber “NORMAN SMITH M.D.” and the drug “DRUG A” to be redeemed by the printed coupon. Line 346 identifies a patient name. Line 348 contains the date that the coupon is given to the patient 214, a carrier number “23” and a group ID number “9” associated with the claim when the coupon is presented at the pharmacy 215. Line 350 identifies the drug to be redeemed by the coupon. Line 352 indicates the dosage. Additionally, an expiration date “May 24, 2000” is specified on line 352 (a rolling voucher expiration date from date printed or a fixed date as defined by pharma brand rules 206). Line 354 provides space for the prescriber's signature, and the prescriber's DEA number is shown next to an area where the prescriber writes his signature. Further, the printed voucher can be customized by the prescriber to include or not include his office phone number and DEA number.

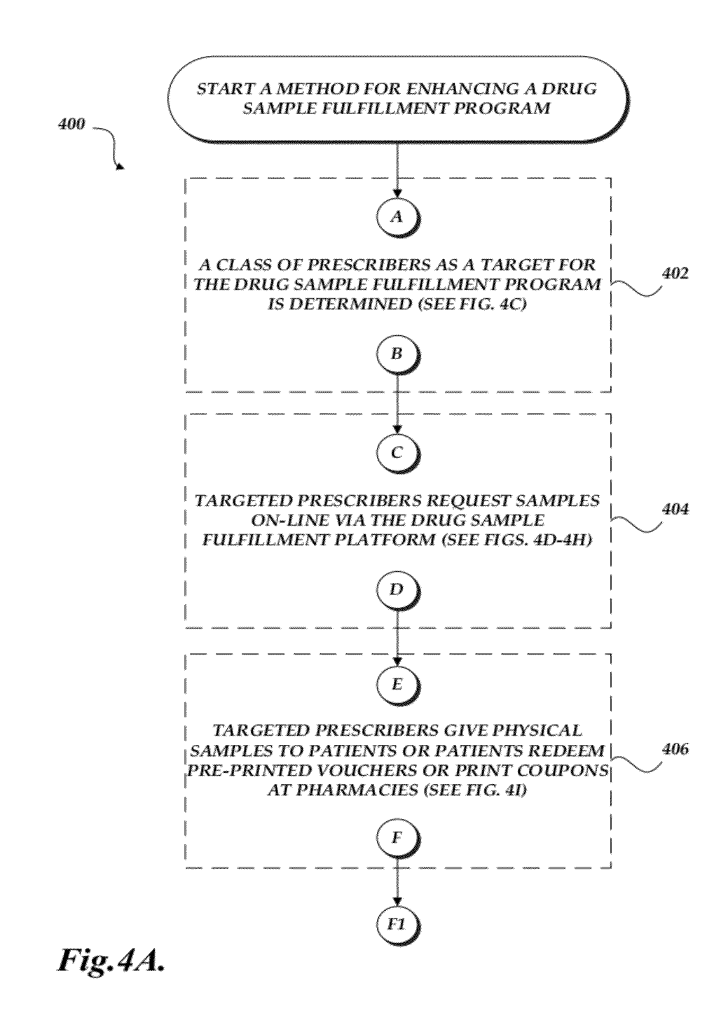

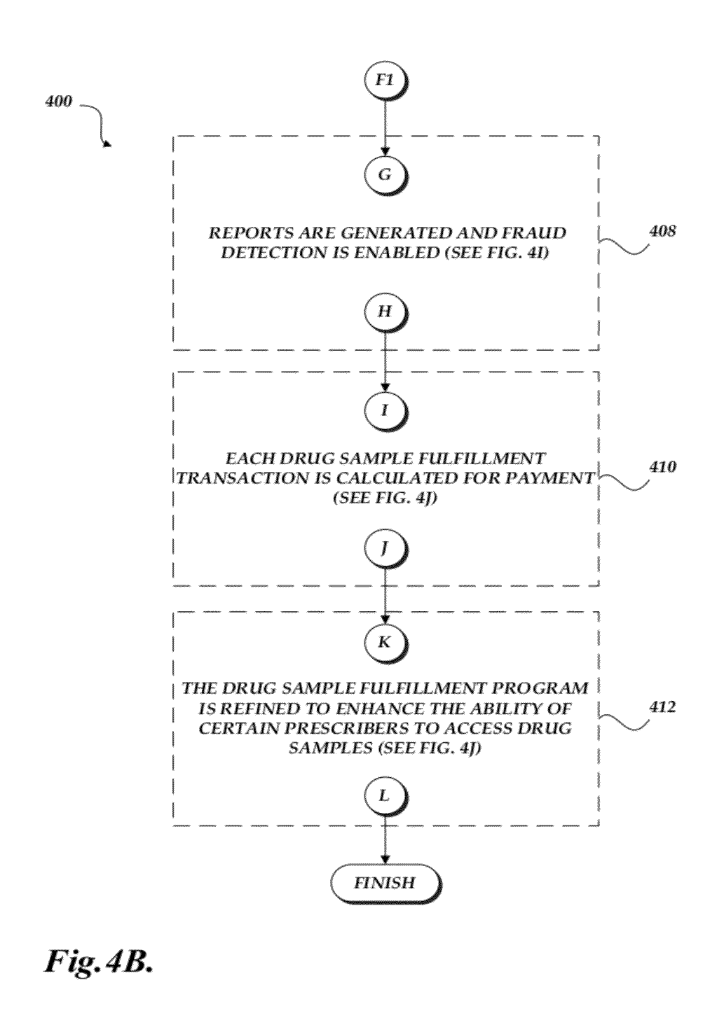

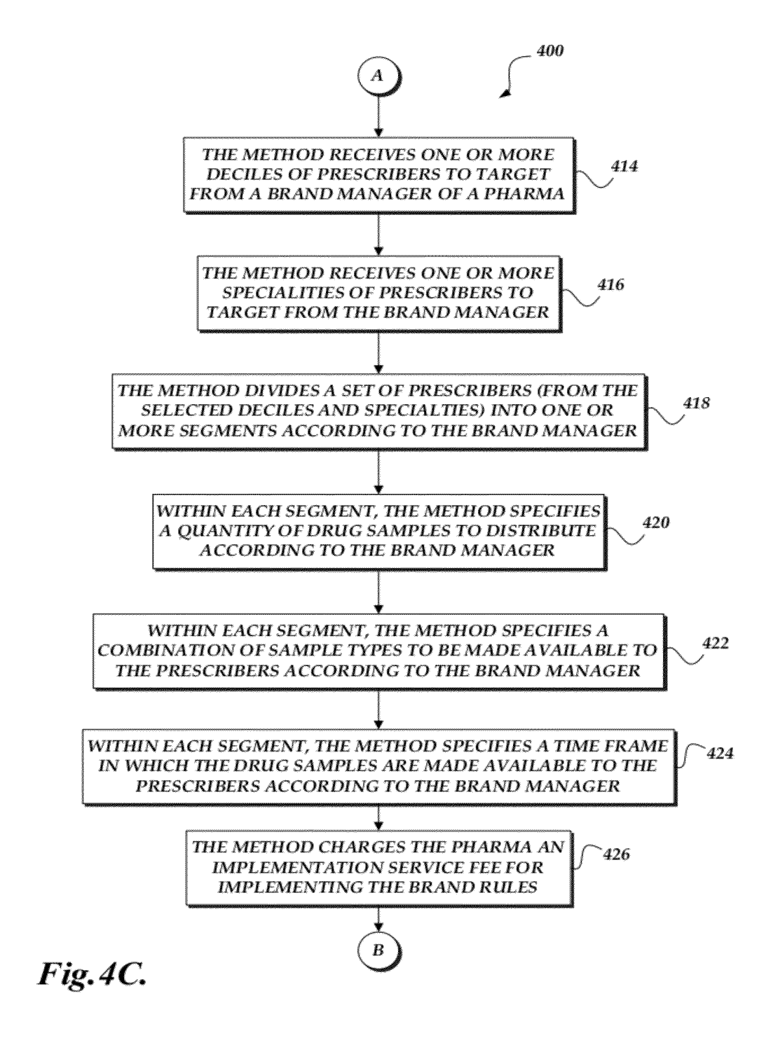

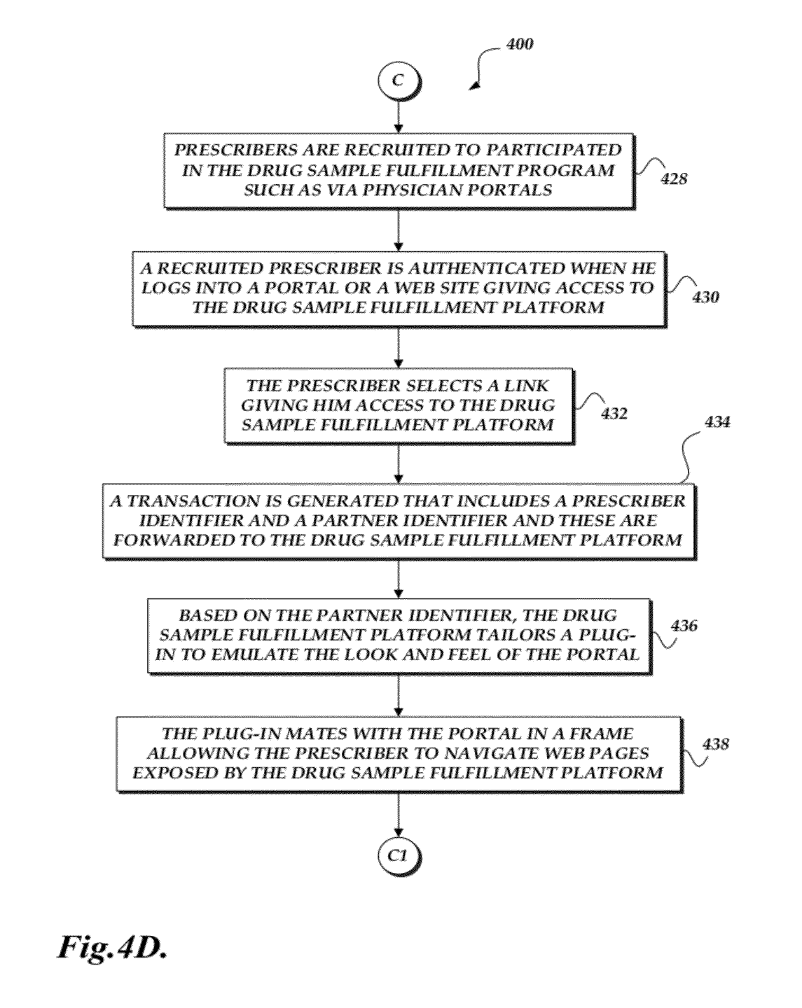

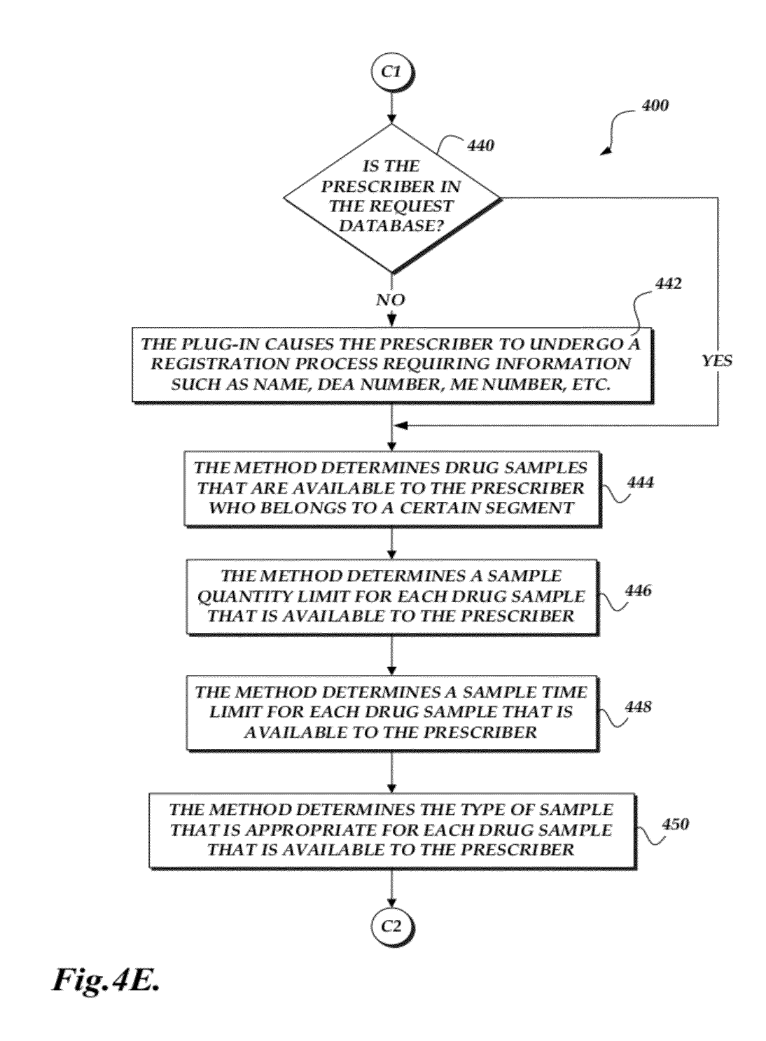

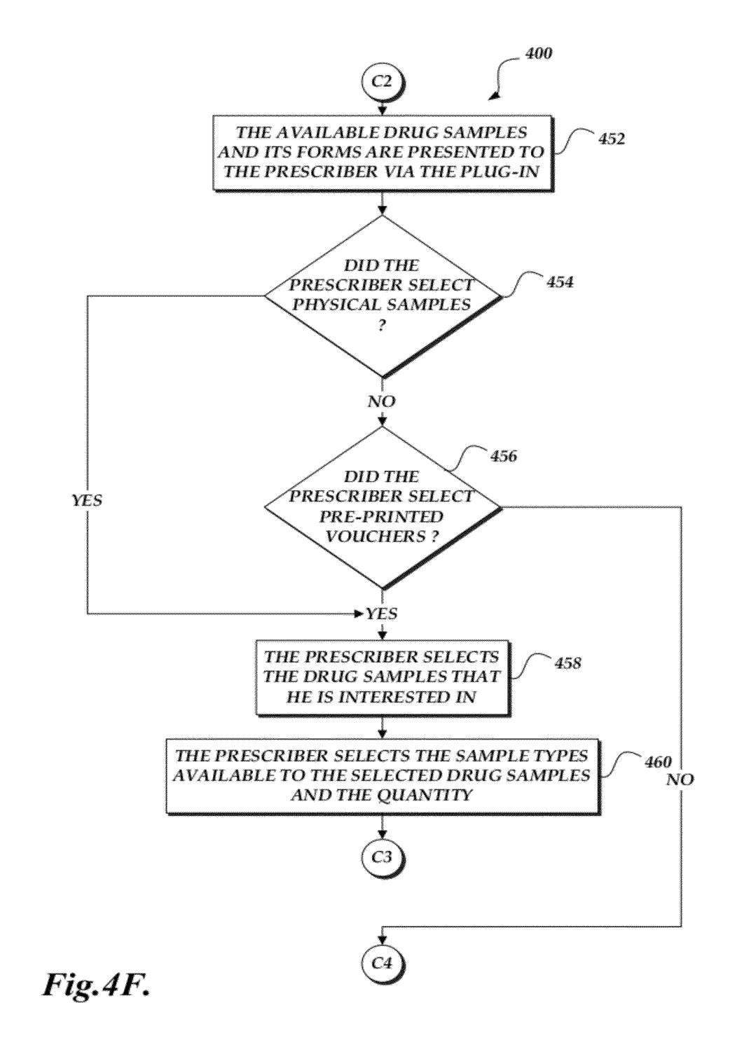

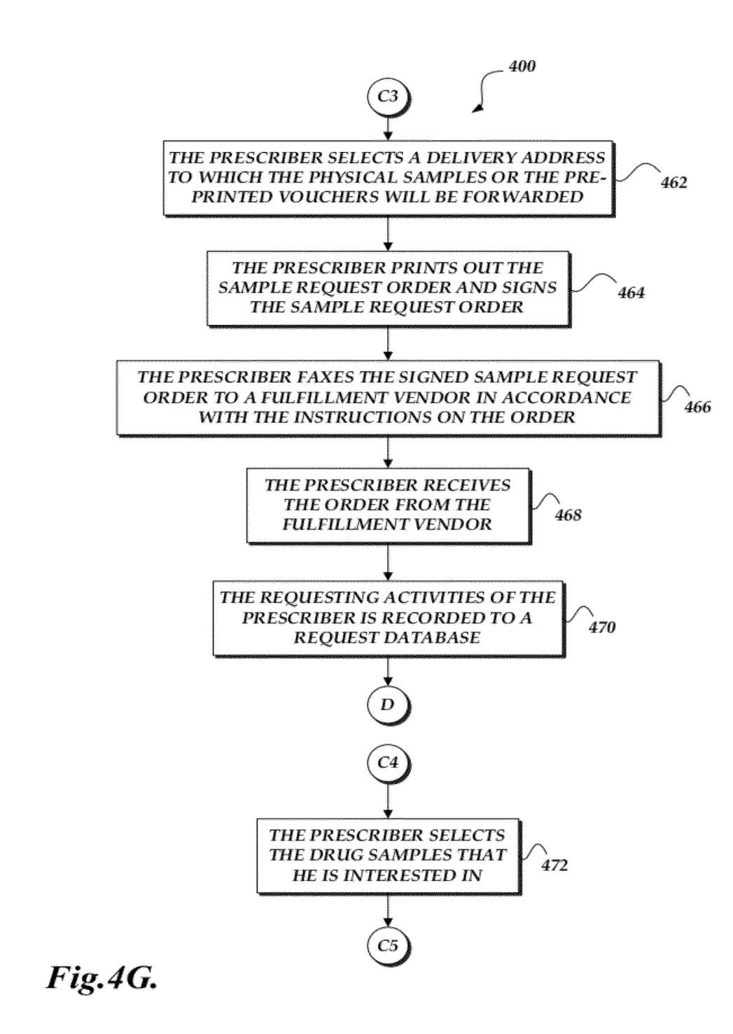

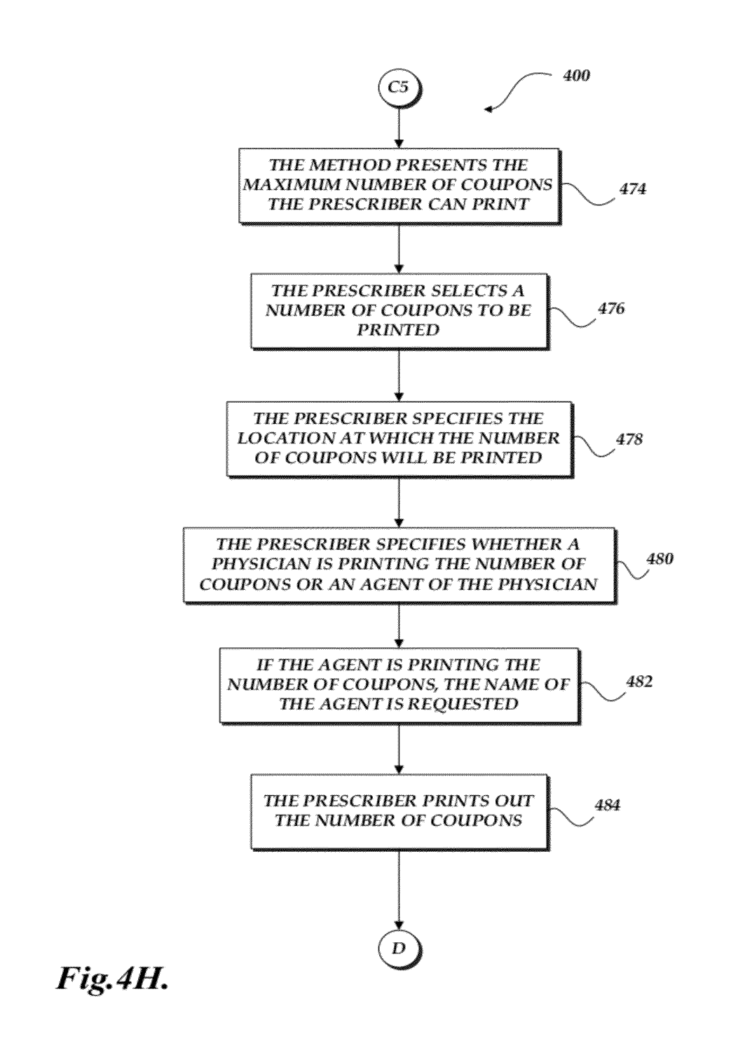

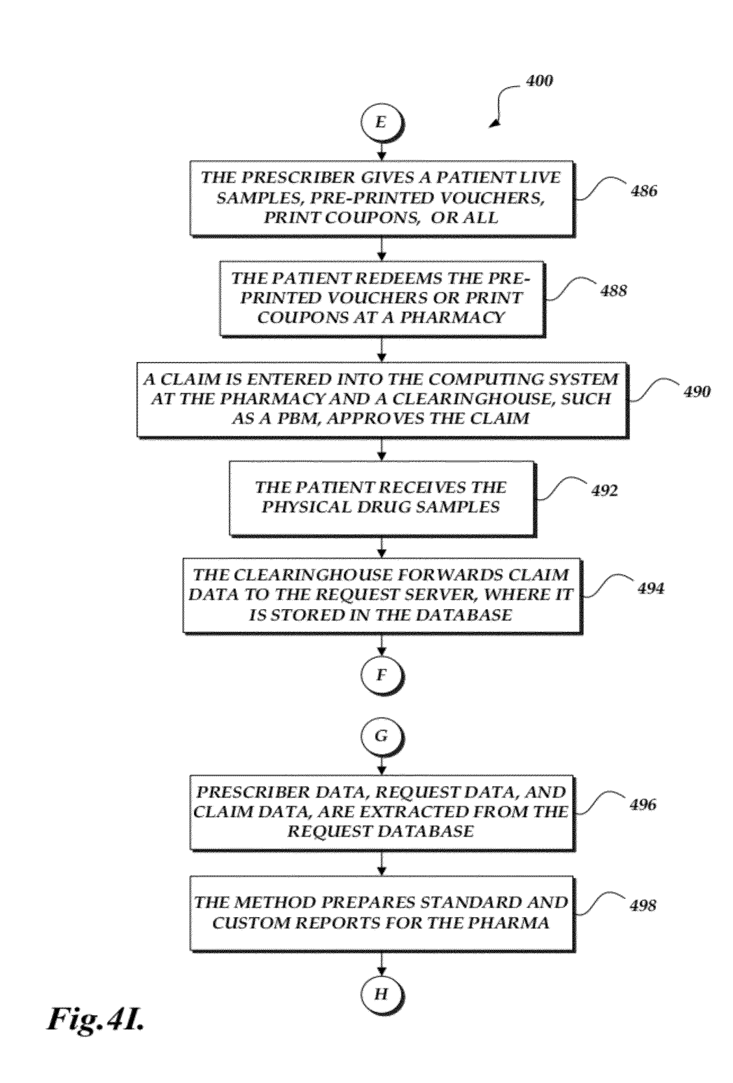

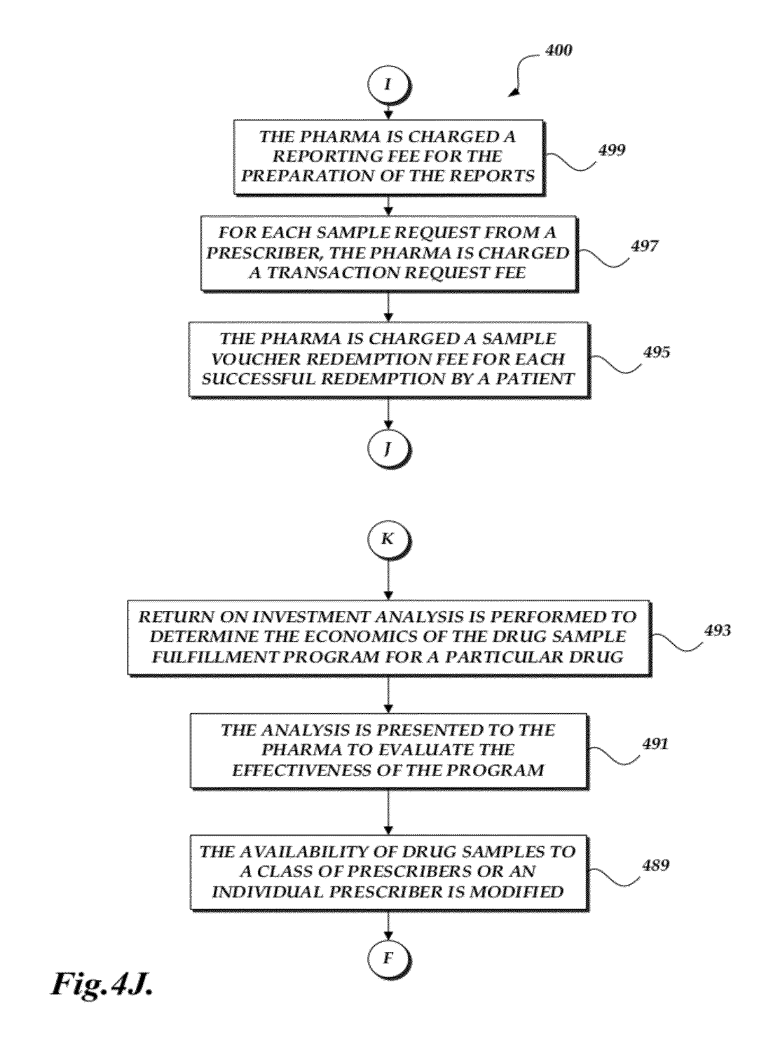

FIGS. 4A-4L illustrate a method 400 for enhancing a drug sample fulfillment program. For clarity purposes, the following description of the method 400 makes references to various elements illustrated in connection with the drug sample fulfillment platform 208 (FIGS. 2A, 2B, 2C), brand rules 206 (FIG. 2A), the drug sample Web site 230 (FIG. 2C), and Web pages 302A-302E (FIGS. 3A-3B). From a start block, the method 400 proceeds to a set of method steps 402, defined between a continuation terminal (“Terminal A”) and an exit terminal (“Terminal B”). The set of method steps 402 describes the commencement of the drug sample fulfillment program by determining a class of prescribers as a target for the drug sample fulfillment program.

From Terminal A (FIG. 4C), the method 400 proceeds to block 414 where the method receives one or more deciles of prescribers to target from the brand manager 304 of the pharma 302. The method 400 also receives one or more criteria to target eligible prescribers as determined by the brand manager 204. See block 416. The method then divides a set of prescribers (from the selected deciles and specialties) into one or more segments according to the brand manager 204. See block 418. At block 420, within each segment, the method 400 specifies a quantity of drug samples to distribute according to the brand manager 204. Next, at block 422, within each segment, the method 400 specifies a combination of sample types or forms (i.e., physical samples, pre-printed vouchers, or print coupons) to be made available to the prescribers 210 according to the brand manager 204. See block 422. Within each segment, the method 400 also specifies a time frame in which the drug samples are made available to the prescribers 210 according to the brand manager 204. See block 424. The method then charges the pharma 202 an implementation service fee for implementing the brand rules as set forth by the brand manager 204. See block 426.

Pharmaceutical companies and their sales representatives have certain rules that they use in determining that prescribers are to be given drug samples in general, as well as which drug samples are to be made available, and the quantity of such drug samples. These rules are established on a prescriber-by-prescriber basis and are in effect when a prescriber requests drug samples. Such rules can be based on many factors, including the specialty of the prescriber, the prescriber's location, the prescriber's age, the prescriber's past history of requesting drug samples and providing such samples to patients, and the prescriber's history in prescribing such drugs. When a prescriber's practice or situation changes, the rules for the prescriber with respect to drug samples provided can also be altered. From here, the method 400 enters the exit Terminal B.

From the exit Terminal B (FIG. 4A), the method 400 proceeds to a set of method steps 404, defined between a continuation terminal (“Terminal C”) and an exit Terminal (“Terminal D”). The set of method steps 404 describes the ways in which targeted prescribers 210 request drug samples on-line via the drug sample fulfillment platform 208.

From Terminal C (FIG. 4D), the method 400 proceeds to block 428 where prescribers 210 are recruited to participate in the drug sample fulfillment program via prescriber-oriented portals, prescriber recruiting services, and/or e-Detailing providers. Other suitable recruitment techniques are possible, such as by telephone or fax. A recruited prescriber 210 is authenticated when he logs into a portal or a Web site giving access to the drug sample fulfillment platform 208. See block 430. This prescriber 210 selects a link on the portal giving him access to the drug sample fulfillment platform 208. See block 432. A transaction is generated when the link is selected that includes a prescriber identifier and a partner identifier and these are forwarded to the drug sample fulfillment platform 208. See block 434. Based on the partner identifier, the drug sample fulfillment platform 208 tailors the Web pages in to emulate the look and feel of the prescriber-oriented portal. See block 436. The application specific messaging protocol allows the prescriber-oriented portal to open the sample fulfillment platform 208 within a frame allowing the prescriber 210 to navigate Web pages. See block 438. The method then enters another continuation terminal (“Terminal C1”).

From Terminal C1 (FIG. 4E), the method 400 proceeds to decision block 440 where a test is made to determine whether the prescriber 210 is in the request database 232. If the answer to the test at decision block 440 is NO, the method 400 proceeds to block 442 where the drug sample fulfillment platform 208 causes the prescriber 210 to complete a registration process requiring information such as name, DEA number, medical state license number, etc. The method 400 proceeds next to block 444. If the answer to the test at decision block 440 is YES, the method 400 also enters block 444. The method 400 determines drug samples that are available to the prescriber (who belongs to a certain segment of prescribers). See block 444. At block 446, the method 400 determines a sample quantity limit for each drug sample that is available to the prescriber 210. At block 448, the method 400 determines a sample time limit for each drug sample that is available to the prescriber. For example, a particular drug is available to a prescriber for a limited duration beyond which he cannot order more. Next, the method 400 determines the type or form of sample that is appropriate for each drug sample that is available to the prescriber 210. See block 450.

Various embodiments of the present invention can also take into consideration certain preferences of a prescriber, such as printing DEA and/or office telephone numbers on the print on-demand voucher. The method 400 then enters another continuation terminal (“Terminal C2”).

From Terminal C2 (FIG. 4F), the available drug samples and its forms are presented to the prescriber 210 via an application specific messaging protocol. See block 452. Next, at decision block 454, a test is made to determine whether the prescriber selected physical samples. If the answer is NO, another test is made at decision block 456 where it is determined whether the prescriber 210 selected pre-printed vouchers. If the answer to the test at decision block 454 or 456 is YES, the method 400 enters block 458. The prescriber 210 selects the drug samples that he is interested in on the Web page 302B. See block 458. Next, at block 460, the prescriber 210 selects the sample types (physical samples or pre-printed vouchers) available for the selected drug samples and quantity. See Web page 302B. The method 400 enters another continuation terminal (“Terminal C3”).

If the answer to the test at decision block 456 is NO, the method 400 enters another continuation terminal (“Terminal C4”).

From Terminal C3 (FIG. 4G), the method 400 proceeds to block 462 where the prescriber 210 selects a delivery address to which the physical samples or the pre-printed vouchers will be sent. See Web page 302B. The prescriber prints out the sample request order and signs the sample request order in one embodiment. In another embodiment, he need not sign the sample request order if it is for pre-printed vouchers 244. See block 464 (see also the Web page 302C). Next, at block 466, the prescriber 210 faxes the signed sample request order 236 to a fulfillment vendor 240 in accordance with the instructions on the sample request order 236. The prescriber 210 receives the order from the fulfillment vendor 240. See block 468. The requesting activities of the prescriber 210 are then recorded in the request database 232. The method 400 then enters the exit Terminal D.

From Terminal C4 (FIG. 4H), the method 400 proceeds to block 472 where the prescriber 210 selects the drug samples for which he is interested in printing out coupons. The coupons that are printed by the prescriber are dynamically built at the time requested so as to include the prescriber's name and address, the particular drug requested, the strength of the drug, the expiration date of the voucher, the prescriber's DEA number, and the trademark and logo not only of the drug, but also of the drug manufacturer. The method 400 then enters another continuation terminal (“Terminal C5”).

From Terminal C5 (FIG. 4I), the method 400 proceeds to block 474 where the method 400 presents the maximum number of coupons the prescriber can print. The prescriber selects the number of coupons to be printed. See block 478 (see also the Web page 302D). The prescriber 210 then specifies whether a physician is printing coupons or whether an agent of the physician is printing them. See block 480 (see also the Web page 302D). If the agent is printing the coupons, the name of the agent is requested by the method 400. See block 482. The prescriber then prints out the number of coupons. See block 484. The method 400 then enters the exit Terminal D.

From the exit Terminal D (FIG. 4A), the method 400 proceeds to a set of method steps 406, defined between a continuation terminal (“Terminal E”) and an exit terminal (“Terminal F”). The set of method steps 406 describes the act of giving physical samples to patients by targeted prescribers 210 or patients 214 redeeming pre-printed vouchers or print coupons at pharmacies.

From Terminal E (FIG. 4J), the prescriber 210 gives the patient 214 physical samples, pre-printed vouchers, print coupons, or all of these. See block 486. The patient 214 redeems the pre-printed vouchers or print coupons at the pharmacy 215. See block 488. A claim is entered into the computer system at the pharmacy 215, and a clearinghouse, such as a pharmacy benefit manager, approves the claim. See block 490. If the claim is approved, the patient 214 receives the physical samples for free. See block 492. The clearinghouse then forwards claim data to the request database 232, where it is stored for later analysis. See block 494. The method 400 then enters the exit Terminal F.

From Terminal F (FIG. 4A), the method 400 proceeds to another continuation terminal (“Terminal F1”). From Terminal F1 (FIG. 4B), the method 400 proceeds to a set of method steps 408, defined between a continuation terminal (“Terminal G”) and an exit terminal (“Terminal H”). The set of method steps 408 describes the commencement of the generation of reports and fraud detection is enabled.

From Terminal G (FIG. 4K), the method 400 proceeds to block 496, where the prescriber data, the request data, and the claim data are extracted from the request database 232. See block 496. The method 400 then proceeds to block 498 where the method 400 prepares standard and custom reports for the pharma 202. There are three types of reports that are possible. One report lists sample demand statistics. For example, the number of drug samples requested by a certain prescriber can be reported. As another example, the number of vouchers or coupons that were redeemed by patients of a particular prescriber can also reported. The second type of report provides promotional response analysis. For example, the correlation of the requested drug samples and the prescribing behavior of a particular prescriber is described. The third type of report focuses on return on investment analysis. For example, the pharma 202 spends a certain amount of money in connection with the drug sample fulfillment program managed by the brand manager 204. The number of prescriptions for the same drug by a certain prescriber can be correlated with the spending of the pharma 202 to generate potential return on investment analysis.

Through the process described above, certain information is captured, including the name of the prescriber, the date of the redemption of the coupon, the identity of the drug sample given, as well as certain information about the patient, but without identifying the patient. This information is made available to the pharma 202 so that vouchers and coupons for sample medications distributed by prescribers can be tracked. The pharma 202 can also obtain information as to the prescribing of the drug in question by a prescriber through the request database 232. In this manner, the pharma 202 can evaluate the effectiveness of providing drug samples to a prescriber, including how often the prescriber prescribes that same drug. This enables the pharma 202 to make determinations, including not only the success of its sample program generally, but also with respect to continuing to make samples of the drug available to the prescriber. The reported information can also be used to identify prescribers who would be good targets for new drugs being introduced by pharmaceutical companies or good candidates for drug focus groups, as well as perhaps for other products and services of interest to prescribers. Lastly, these reports can be utilized by sales representatives for the purpose of generating and distributing sample vouchers to their targeted prescriber clientele.

The information generated in these reports also aids in fraud analysis. For a given prescriber, an allocation limit for drug samples associated with that prescriber is known. Moreover, the time frame in which those drug samples are valid is also known and specified in the brand rules 206 by the brand manager 204. Based on the redemptions that come in via the claim data provided by the claim processor 250, fraud analysis can determine whether more vouchers or coupons were redeemed within the time frame limit than had been allocated. If there is an inconsistency between the allocation limit and the number of redeemed vouchers or coupons by patients, a flag is raised for further investigation. Preferably, the pre-printed vouchers and print coupons contain the prescriber's DEA number or other identifying indicia for accurate fraud detection analysis. The method 400 then enters the exit Terminal H.

From Terminal H (FIG. 4B), the method 400 proceeds to a set of method steps 410, defined between a continuation terminal (“Terminal I”) and an exit terminal (“Terminal J”). The set of method steps 410 describes the payment calculation for each drug sample fulfillment transaction.

From Terminal I (FIG. 4L), the method 400 proceeds to block 499, where the pharma 202 is charged a reporting fee for the preparation of the reports generated in the set of method steps 408. For each request for a sample from a prescriber, the pharma 202 is also charged a transaction request fee. See block 497. The pharma 202 is also charged a sample voucher redemption fee for each successful redemption of a print coupon or a pre-printed voucher by the patient 214. See block 495. Not shown is an annual fee charged to the pharma 202 for the use of the drug sample fulfillment platform 208 and the maintenance of the drug sample fulfillment platform 208. Software updates as well as customization of various brand rules specified by the brand manager fall under this fee. The method 400 then enters the exit Terminal J.

From Terminal J (FIG. 4B), the method 400 proceeds to a set of method steps 412, defined between a continuation terminal (“Terminal K”) and an exit terminal (“Terminal L”). The set of method steps 412 describes the commencement of the refining of the drug sample fulfillment program to enhance the ability of certain prescribers 210 to access drug samples.

From Terminal K (FIG. 4M), the method 400 proceeds to block 493 where a return on investment analysis is performed to determine the economics of the drug sample fulfillment program for a particular drug. The analysis is then presented to the pharma 202 to evaluate the effectiveness of the program. See block 491. The availability of drug samples to a class of prescribers 210 or an individual prescriber is then modified. See block 489. From there the method 400 proceeds to the exit Terminal F and finishes execution.

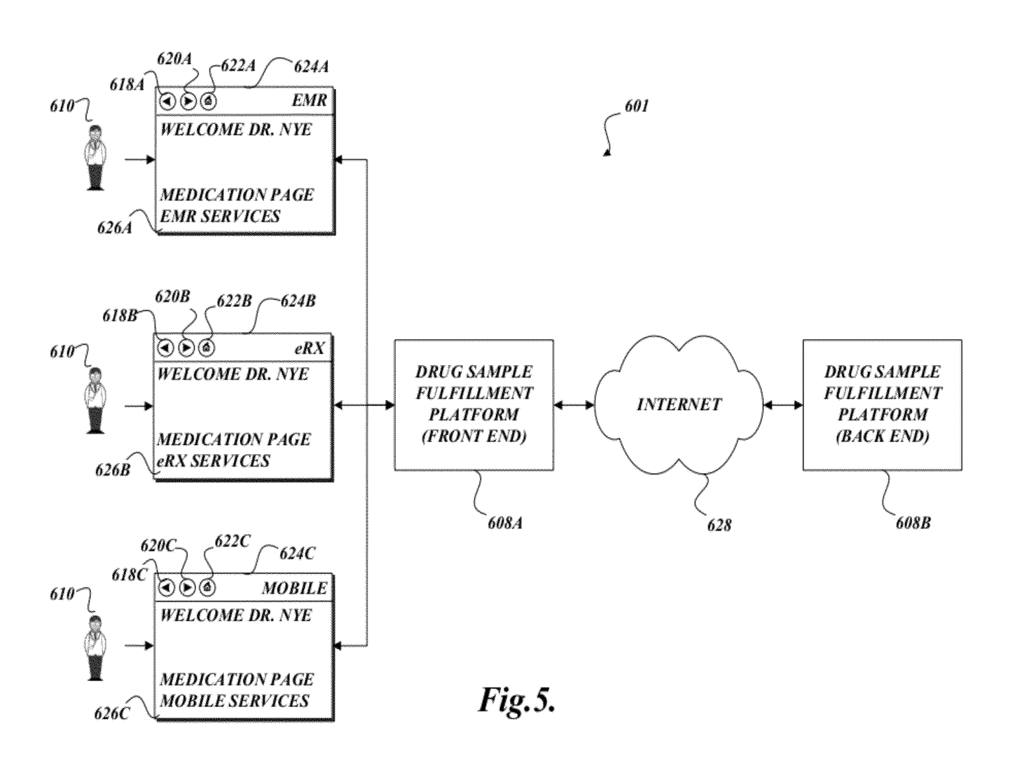

FIG. 5 illustrates a system 601 in which a prescriber 610 interacts with the drug sample fulfillment platform 608a, 608b via various intermediaries, such as an electronic medical record application 624a, an electronic prescribing application 624b, and a mobile application 624c executing on a mobile device. The system 601 is a network computing environment that has pieces of hardware and software applications. The prescriber 610 interacts with the resources of the system 601 via personal computers, tablet computers, or mobile devices (not shown). The electronic medical record application (EMR) 624a, the electronic prescribing application (eRX) 624b, and the mobile application 624c run on computers, such as personal computers, tablet computers, or mobile devices.

These applications 624a-624c are software that let the prescriber 610 interact with user interfaces 626a-626c and access content and software services related to those user interfaces on the drug sample fulfillment platform 608a, 608b. User interfaces 626a-626c include a number of tools for navigation, such as back buttons 618a-618c; forward buttons 620a-620c; and home buttons 622a-622c. These buttons are suitably positioned on navigation bars allowing easy access to previous user interfaces, present interfaces, and next user interfaces by the prescriber 610. Various applications 624a-624c are each a starting point to the system 601 that serves as a collection of links, content, and services designed to guide the prescriber 610 to drug sample offers and their distribution.

User interfaces 626a-626c include greetings that identify the prescriber, who is a user of a particular application 624a-624c, such as “WELCOME DR. NYE” for the prescriber 610. User interfaces 626a-626c include a selectable button or hyperlink “MEDICATION PAGE” that allows access to offered drug samples personalized to the prescriber 610, and other selectable buttons or hyperlinks “EMR SERVICES,” “eRX SERVICES,” and “MOBILE SERVICES.” These latter selectable buttons or hyperlinks “EMR SERVICES,” “eRX SERVICES,” and “MOBILE SERVICES” of user interfaces 626a-626c allow the prescriber 610 to access other services specific to the corresponding applications. The links, content, and services exposed through various user interfaces 626a-626c are made available by the drug sample fulfillment platform 608a, 608c via a network 628. The network 628 is a group of computers and associated devices that are interconnected by communication facilities, such as the Internet. The drug sample fulfillment platform 608a, 608c is one or more computers or one or more programs executing on one or more computers that respond to requests of users, such as the prescriber 610, to access content for user interfaces 626a-626c, such as offered drug samples targeted for a patient of the prescriber 610.

The application 624a is an electronic medical record which is a computerized media created for organizations that deliver health care, such as a hospital or a physician's office. Through the electronic medical record application 624a, the prescriber 610 may access the selectable button or hyperlink “MEDICATION PAGE” to access offered drug samples presented by the drug sample fulfillment platform 608a, 608b. Similarly, the electronic prescribing application 624b is a piece of software that facilitates the electronic transmission of prescription information from the prescriber 610 through his computer to a pharmacy computer. It obviates the need for a paper prescription that a patient of the prescriber 610 would have otherwise carried to the pharmacy. The electronic prescribing application 624b contains a selectable button or hyperlink “MEDICATION PAGE” through which the prescriber 610 can access offered drug samples collated by the drug sample fulfillment platform 608a, 608b. In one embodiment, the electronic prescribing application 624b exists as a service within the electronic medical record application 624a through which the prescriber 610 can invoke its functionalities. The mobile application 624c presents a selectable button or hyperlink “MEDICATION PAGE” through which the prescriber 610 obtains a list of offered drug samples by the drug sample fulfillment platform 608a, 608b. The mobile application 624c is designed to be executed on a mobile computing device, such as a tablet computer or a mobile phone.

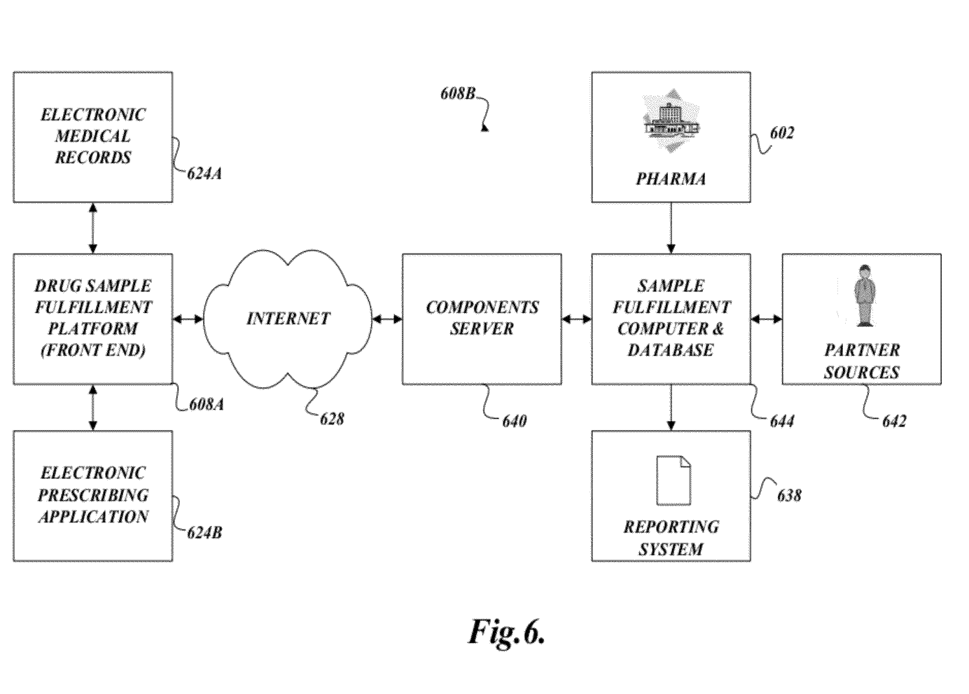

FIG. 6 illustrates the drug sample fulfillment platform 608b (back end) in greater detail. Specifically, the back end of the drug sample fulfillment platform 608b facilitates various drug sample services, such as offered drug samples in the form of electronic samples, electronic coupons, and electronic vouchers; drug information; e-details; drug safety alerts; risk evaluation and mitigation strategy information; and patient information. These services, among others, are presented to the prescriber 610 within the context of various applications 624a-624c when the prescriber 610 is looking up a patient record and is in the process of prescribing or documenting an encounter with his patient.

Typically, such looking up or prescribing or documenting occur via the execution of applications 624a-624c. In one embodiment, the electronic samples, electronic vouchers, and electronic coupons are presented to the prescriber 610 via a selectable button or hyperlink “MEDICATION PAGE” within the context of an electronic medical record, electronic prescribing process, or mobile services. These services are providing electronic samples, electronic vouchers, and electronic coupons to the prescriber 610 for prescribing to his patients, which is facilitated by the sample fulfillment platform 608b in the back end.

A life science client, such as a pharma 602, engages a sample fulfillment computer and database 644 to provide their brand rules governing the distribution of their electronic vouchers, electronic coupons, and electronic samples to prescribers, such as the prescriber 610, at a particular point of care, such as during an electronic medical record encounter or an electronic prescribing encounter, or a mobile point of care. Specifically, the time frame, dosages and quantity of drug samples are different for different prescribers or different patients depending on brand rules of the pharma 602. The time frame, dosages, and quantity of drug samples may also be different depending on a computing site of a healthcare organization that hosts the electronic medical record application, electronic prescribing application, or the mobile application. The pharma 602 provides other professional services that may be made available through the sample fulfillment computer and database 644, such as client services; medical, legal, and regulatory processes; production; quality assurance process; deployment; maintenance; hosting; and reporting.

The sample fulfillment computer and database 644 may interact with the pharma 602 to get the branded electronic vouchers, electronic coupons, and electronic samples; or alternatively, it could facilitate through intermediaries who are aggregators of electronic vouchers, electronic coupons, and electronic samples from several brands of various pharmaceutical companies. The sample fulfillment computer and database 644 builds a repository, closet, cabinet, or list of these electronic vouchers, electronic coupons, and electronic samples. The intermediaries include partner sources 642. Using brand rules or other business and eligibility rules, the sample fulfillment computer and database 644 executes a process by which electronic vouchers, electronic coupons, and electronic samples are made eligible and determines which rules should be implemented and to whom these drug sample offers should be made available.

For example, one electronic voucher or electronic coupon or electronic sample could be made available only when a prescriber is in the electronic medical record of a male patient over the age of 45 with Type 2 diabetic conditions, and so on. In addition, the sample fulfillment computer and database 644 formulates targeted health care professionals' information; brand, business, and eligibility rules which can be separated by service or component; contents of the drug sample offers by service or component; collating activity data; and templates or style sheets that are suitable to present the drug sample offers and other information dependent on the context of the encounter between the prescriber 610 and his patients.

The sample fulfillment computer and database 644 interacts with the components server 640 to communicate with electronic medical records application 624a, the electronic prescribing application 624b, or mobile application 624c to integrate its services with the services of the various applications 624a-624c so that the drug sample offers would be presented to the prescriber 610 through various user interfaces 626a-626c. Suitably, the components server 640 includes a number of components, such as electronic vouchers, electronic coupons, and electronic samples; patient education information; risk evaluation and mitigation strategy information; drug safety alerts; and drug monograph. The components server 640 communicates with the drug sample fulfillment platform front end 608a via various application programming interfaces that occur in real time. Some of the information or queries that are provided between the components server 640 and the drug sample fulfillment platform front end 608a include a daily, real time Web feed; eligibility check; various pieces of information; and search requests coming from various applications 624a, 624c for drug sample offers. Suitably, the application programming interface can be implemented using any protocol including Windows Communication Foundation protocol.

A reporting system 638 is coupled to the sample fulfillment computer and database 644 to provide reporting services and analytic services. For example, various reports are possible using the reporting system 638 including internal/external identification; activity and other matrixes; and tools to provide access to reports.

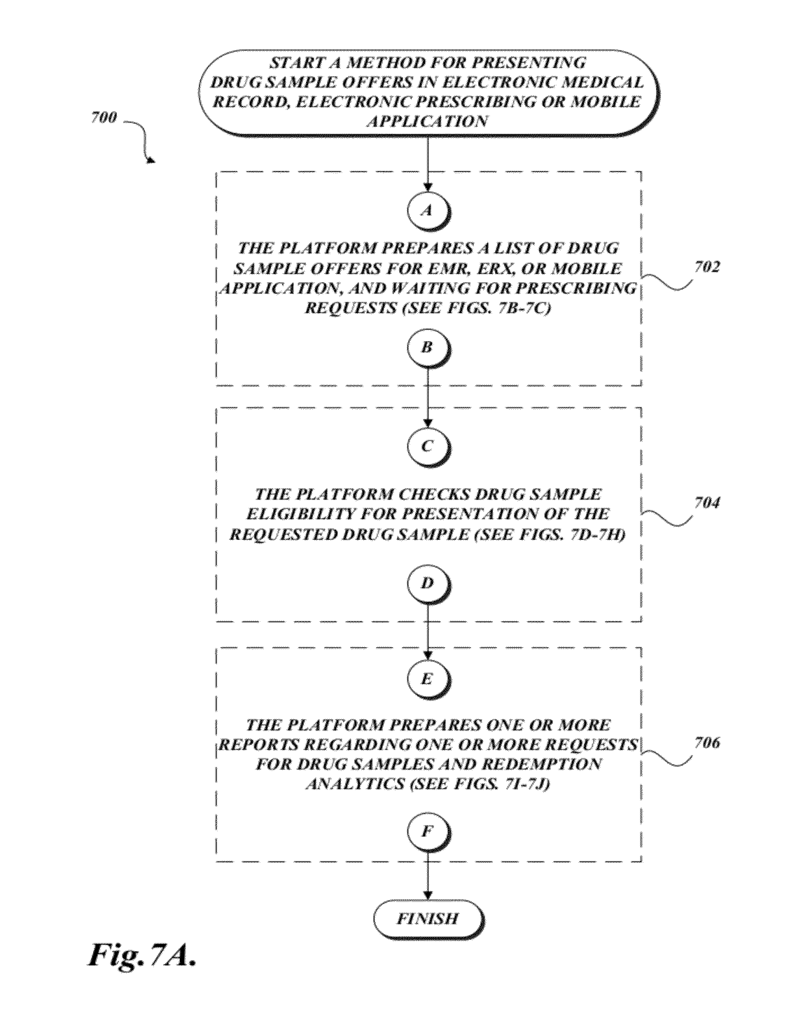

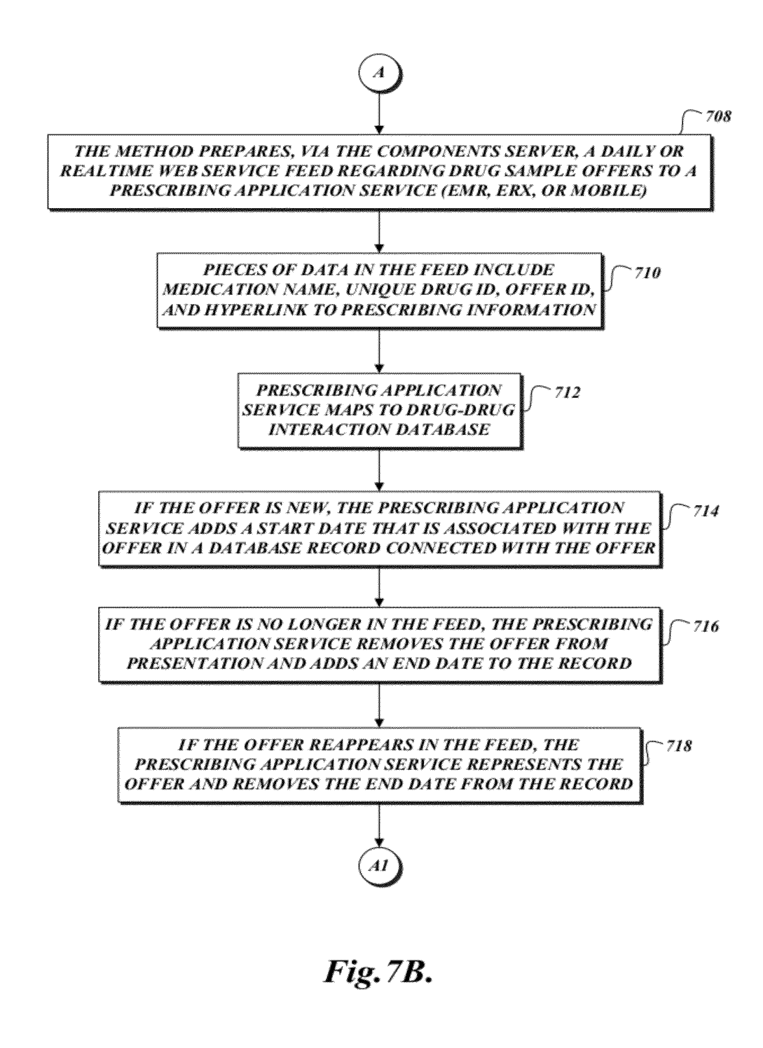

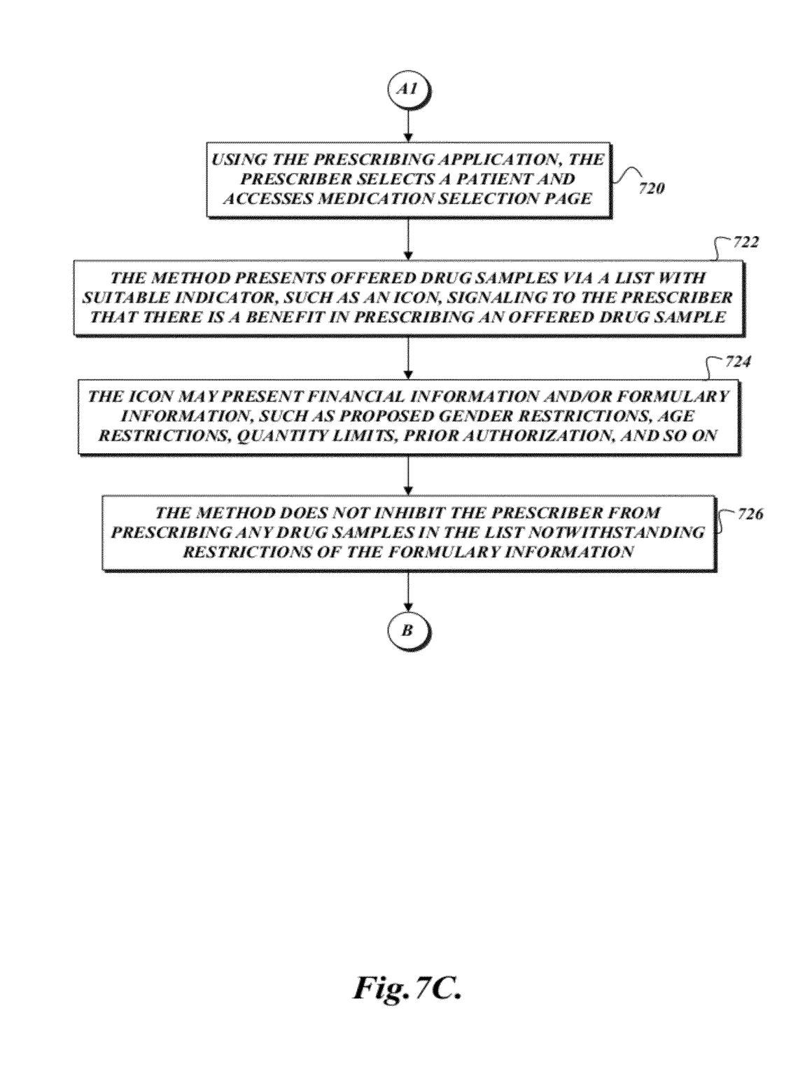

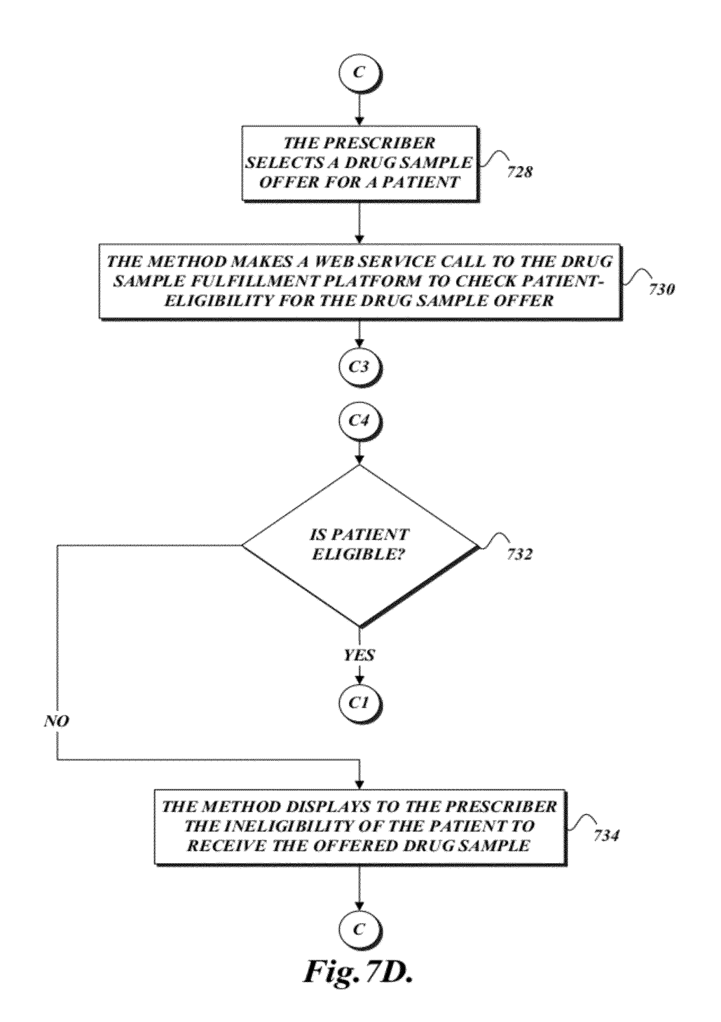

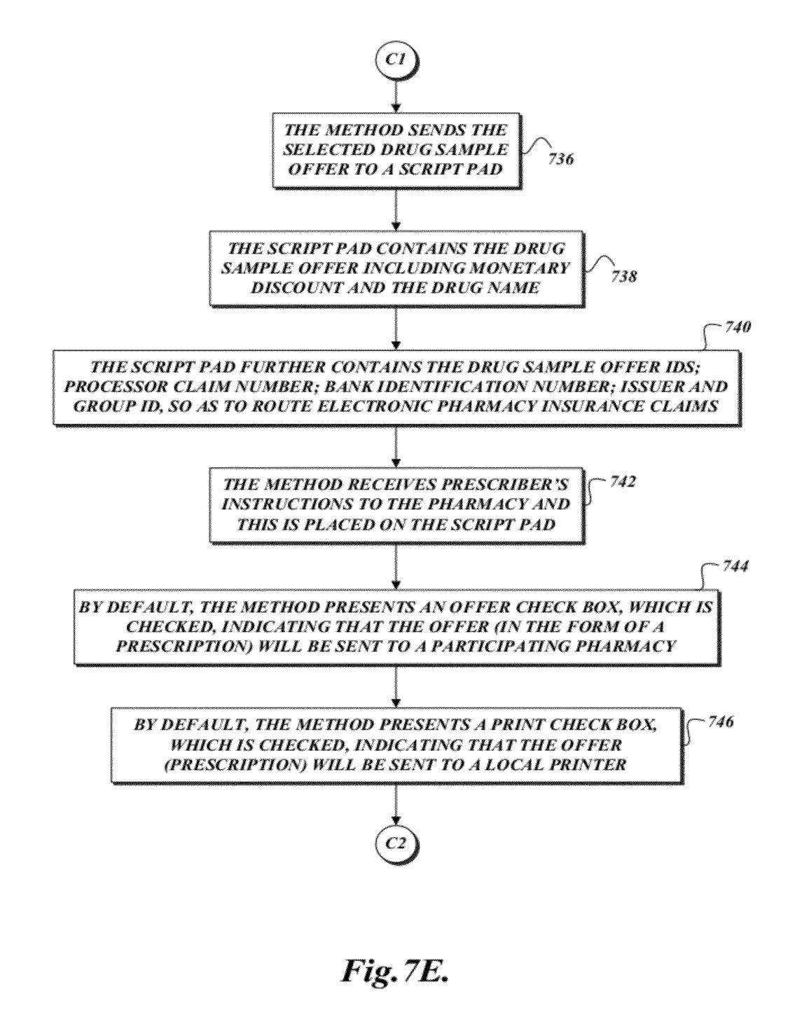

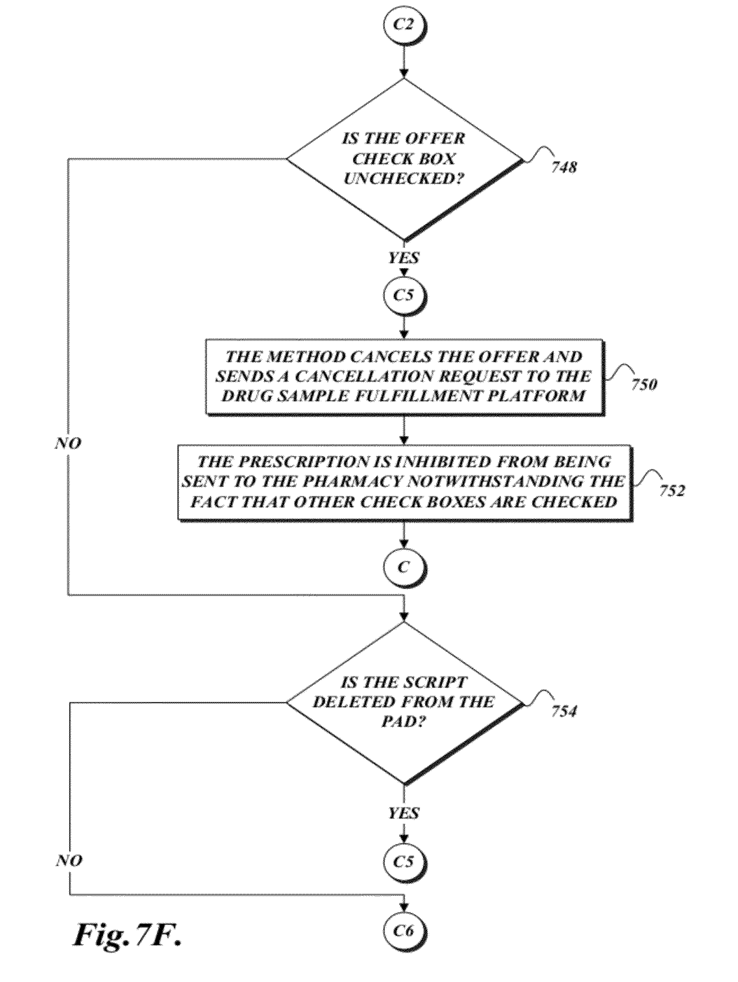

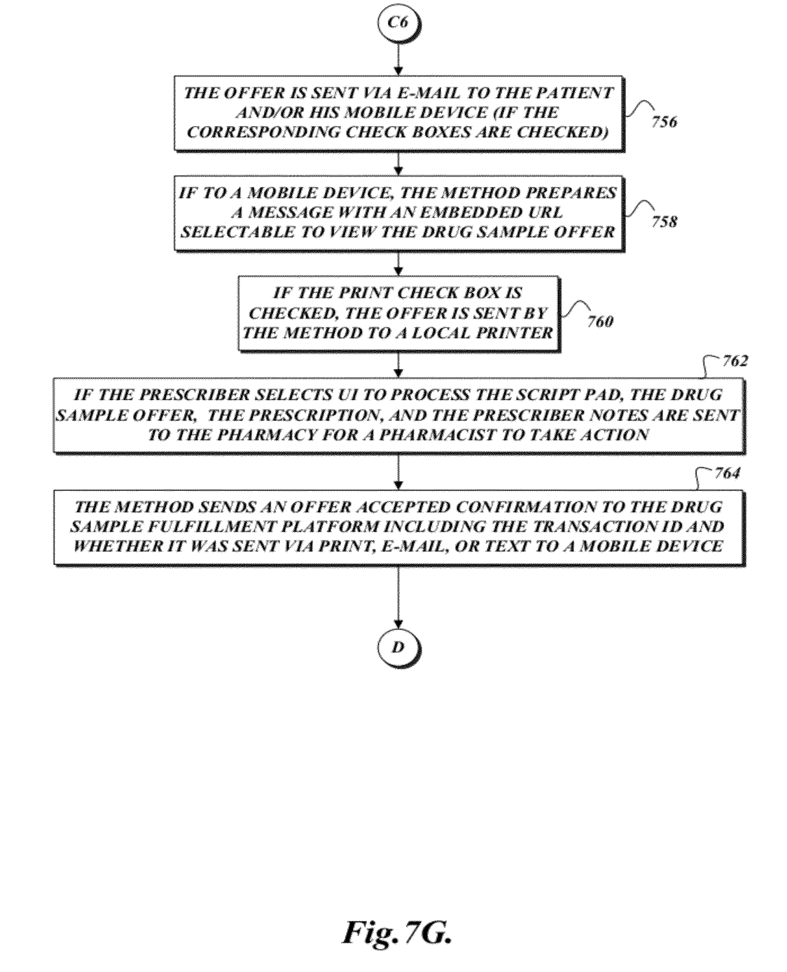

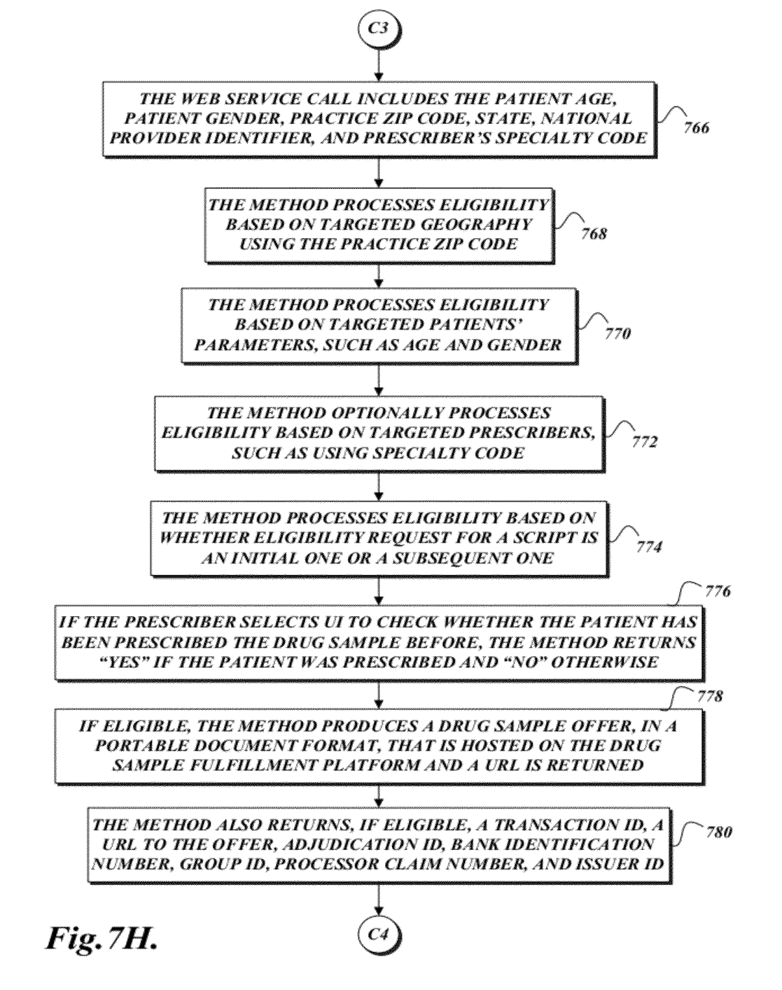

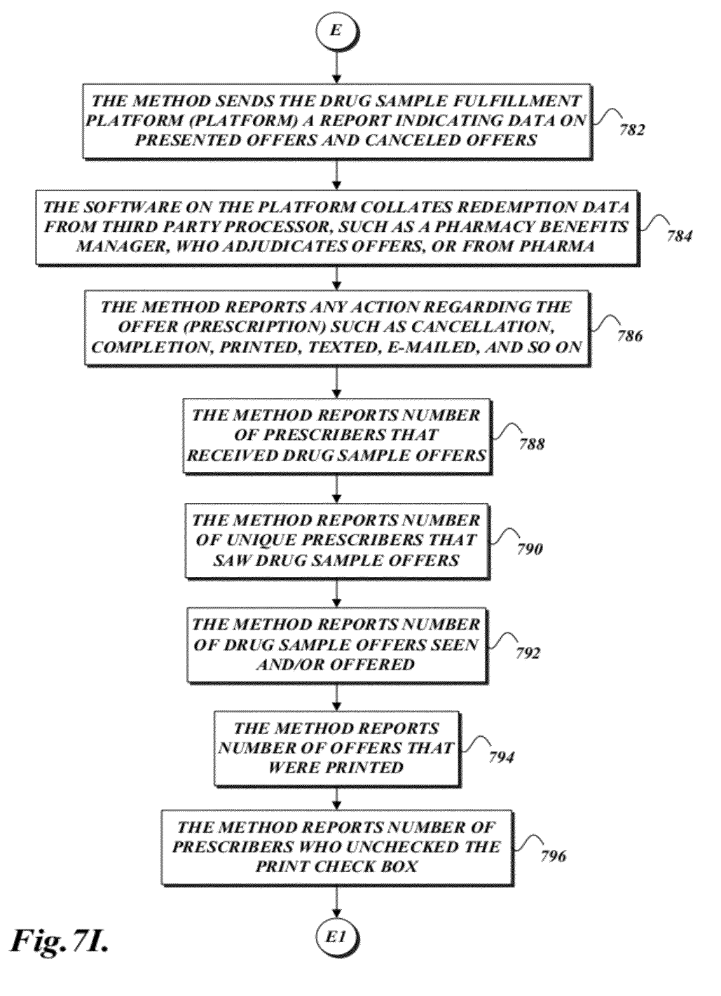

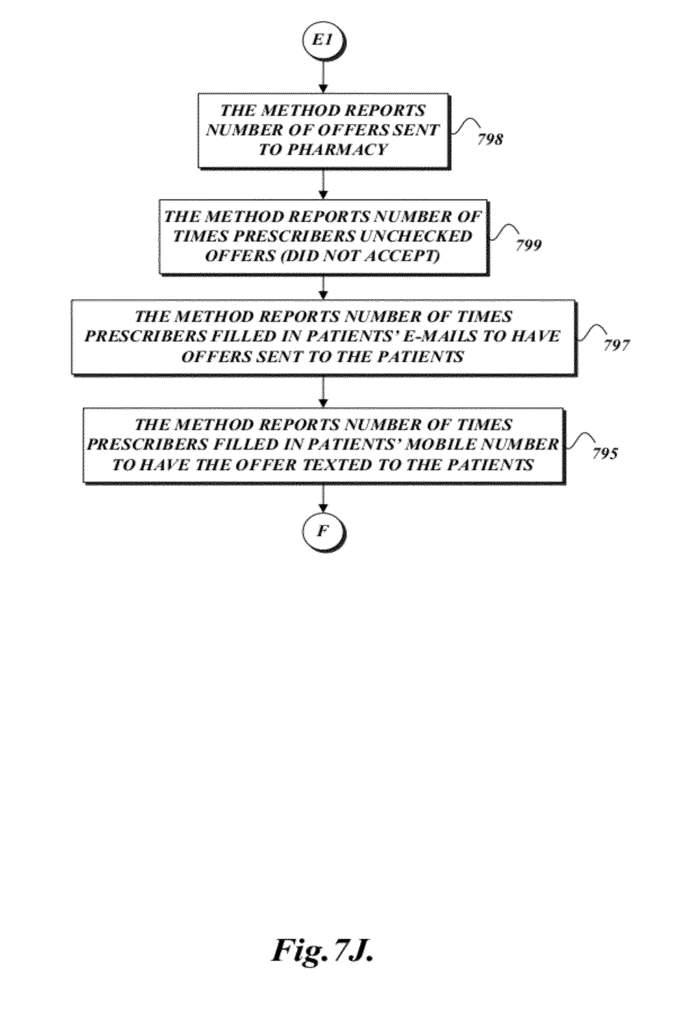

FIGS. 7A-7J illustrate a method 700 for presenting drug sample offers via electronic medical record application, electronic prescribing application, or mobile application. For clarity purposes, the following description of the method 700 makes references to various elements illustrated in connection with the drug sample fulfillment platform 608a, 608b (FIGS. 5, 6). From a start block, the method 700 proceeds to a set of method steps 702, defined between a continuation terminal (“Terminal A”) and an exit terminal (“Terminal B”). The set of method steps 702 describes the preparation of an electronic sample cabinet, or list, or medication page for electronic medical record application, electronic prescribing application, or mobile application. Furthermore, these method steps 702 wait for prescribing requests from the prescriber 610.

From Terminal A (FIG. 7B), the method proceeds to block 708 where the method prepares, via the components server 640, a daily or real time Web service feed regarding drug sample offers to the prescribing application service, such as electronic medical record, electronic prescribing, or mobile application. In one embodiment, the Web service feed is formatted in XML and contains a listing of drug sample offers. However, other suitable tag-based languages may be used besides XML. At block 710, pieces of data in the feed include medication name, unique drug ID, offer ID, and a hyperlink to prescribing information. In one embodiment, the hyperlink, upon selection, takes the prescriber 610 to prescribing information which is hosted by the pharma 602. In the same embodiment, there is a character limit for the hyperlink of a suitable number of characters, such as 500 characters. In the same embodiment, the hyperlink has a particular format, such as http://www.example.com. In other embodiments, the hyperlink may take the prescriber 610 to other providers of drug samples, such as intermediaries.

At block 712, the prescribing application service maps to a drug-drug interaction (DDI) database. In one embodiment, the method 700 allows the same drug sample offer for different drug samples. In other embodiments, one drug sample offer is available for a particular drug sample. At block 714, if the offer is new, the prescribing application service adds a start date that is associated with the offer in a database record connected with the offer. At block 716, if the offer is no longer in the feed, the prescribing application service removes the offer from presentation to the prescriber 610 and adds an end date to the record. At block 718, if the offer reappears in the feed, the prescribing application service represents the offer and removes the end date from the record. The method then continues on to another continuation terminal (“Terminal A1”).

From Terminal A1 (FIG. 7C), the method 700 proceeds to block 720 where, using the prescribing application, the method receives a selection from the prescriber 610 a patient with whom the prescriber 610 has an encounter, and further facilitates access by the prescriber 610 to the medication selection page from which the prescriber 610 may prescribe drug samples to the patient. At block 722, the method presents offered drug samples via a list with a suitable indicator, such as an icon, signaling to the prescriber 610 that there is a benefit in prescribing an offered drug sample. In one embodiment, the icon includes the “$” symbol. In another embodiment, there could be more than one drug sample offer for a particular medication. At block 724, the icon may present financial information and/or formulary information, such as proposed gender restrictions, age restrictions, quantity limits, prior authorization, and so on. At block 726, the method does not inhibit the prescriber 610 from prescribing any drug samples that are offered in the list notwithstanding restrictions of the formulary information. The method 700 then continues to Terminal B.

From Terminal B (FIG. 7A), the method 700 proceeds to a set of method steps 704, defined between a continuation terminal (“Terminal C”) and an exit terminal (“Terminal D”). The set of method steps 704 facilitates the drug sample fulfillment platform 608a, 608b to check for drug sample eligibility for presentation of the requested drug sample to the prescriber 610. From Terminal C (FIG. 7D), the method 700 proceeds to block 728 where the method receives a selection from the prescriber 610 of a drug sample offer for his patient. At block 730, the method makes a Web service call to the drug sample fulfillment platform 608a, 608b to check patient eligibility for the drug sample offer. The method then continues to another continuation terminal (“Terminal C3”).

From Terminal C3 (FIG. 7H), the method 700 proceeds to block 766 where the Web service call includes the patient's age and gender, as well as the prescriber's practice zip code, state, national provider identifier, and specialty code. The drug sample fulfillment platform 608a, 608b processes the information passed by the application (EMR, eRX, or mobile) to determine whether the patient of the prescriber 610 is eligible for the drug sample offer and returns a Web service call to the application that semantically indicates “Yes, the patient is eligible, show the offer to the patient.” Otherwise, the Web service call returns semantically indicates “No, the patient is not eligible, and please do not show the offer to the patient” to the application that invoked the Web service call originally.

More specifically, the method at block 608 processes eligibility based on targeted geography using the practice zip code of the prescriber 610. At block 770, the method processes eligibility based on targeted patients' parameters, such as age and gender. At block 772, the method optionally processes eligibility based on targeted prescribers, such as using the specialty code. At block 774, the method processes eligibility based on whether the eligibility request for a script is an initial one or a subsequent one. In one embodiment, the method may present the drug sample offer for an initial prescription and a different or another drug sample offer to the patient's subsequent prescription unless, of course, the prescriber 610 indicates that the prescription is attached to a refill order. Otherwise, in the same embodiment, more than one prescription and drug sample offer could be provided to the patient. At block 776, if the prescriber selects the user interface to check whether the patient has been prescribed the drug sample before, the method returns “Yes” if the patient was prescribed and “No” otherwise. In some embodiments, there is no drug sample offer for refills. In some other embodiments, the drug sample offer suitably is in a portable document format that is hosted on the drug sample fulfillment platform 608b. A hyperlink is provided to the application to the drug sample offer that is in the portable document format. This hyperlink is provided when eligibility of the patient is confirmed. At block 778, if eligible, the method produces a drug sample offer, in a portable document format, that is hosted on the drug sample fulfillment platform 608b, and a URL such as a hyperlink is returned to the application. At block 780, the method also returns, if eligible, a transaction ID, a URL to the offer, adjudication ID, bank identification number, group ID, process claim number, and issuer ID. The method then continues to another continuation terminal (“Terminal C4”).

From Terminal C4 (FIG. 7D), the method 700 proceeds to decision block 732 where a test is performed to determine whether the patient is eligible. If the answer to the test at decision block 732 is YES, the method 700 proceeds to another continuation terminal (“Terminal C1”). Otherwise, the answer to the test at decision block 732 is NO, and the method 700 proceeds to block 734 where the method displays to the prescriber 610 through the application the ineligibility of the patient to receive the offered drug sample. The method 700 then proceeds to Terminal C and skips back to block 728 where the above-identified processing steps are repeated.

From Terminal C1 (FIG. 7E), the method 700 proceeds to block 736 where the method sends the selected drug sample offer to a script pad. At block 738, the script pad contains the drug sample offer including monetary discount and the drug name. For example, a textual description “$20 off drug X” is possible. As another example, “Pay $11 on every prescription of Omnaris” is also possible. Other suitable textual descriptions of the drug sample offers can be used. In one embodiment, there is a character limit of a suitable number of characters, such as 50 characters (including spaces) that accommodate textual descriptions. In the same embodiment, a particular font is selected by the application. In the same embodiment, the color of the text is not selectable. Other embodiments are possible with different character limits, font selection, text in combination with graphics, color, and so on.

At block 740, the script pad further contains the drug sample offer IDs; processor claim number; bank identification number; and issuer and group ID, which is used to route electronic pharmacy insurance claims. At block 742, the method receives prescriber's instructions to the pharmacy, which are placed on the script pad. In one embodiment, a character limitation of a number of characters, such as 210 characters, limits the amount of instructions that can be forwarded to the pharmacy. In other embodiments, more or less than 210 characters is possible.

At block 744, by default, the method 700 presents an offer check box, which is checked, indicating that the offer (in the form of a prescription) will be sent to a participating pharmacy. At block 746, by default, the method 700 presents a print check box, which is checked, indicating that the offer (prescription) will be sent to a local printer. In one embodiment, the method inhibits the application from defaulting to an unchecked offer check box for automatically sending the prescription to the participating pharmacy so as to require the prescriber 610 to take an active selection to have the drug sample offer in the form of the prescription to be sent directly to the participating pharmacy. In other embodiments, it is possible to default to an unchecked offered check box if that is globally done for all applications, for every drug sample offer from every pharma, and for every prescriber. The method then continues to another continuation terminal (“Terminal C2”). In some other embodiment, if the prescriber 610 unchecks a “one month free voucher” check box or unchecks “apply all patient offers” check box, this is recorded as a canceled offer by the method 700.

From Terminal C2 (FIG. 7F), the method 700 proceeds to decision block 748 where a test is performed to determine whether the offer check box is unchecked. If the answer is YES to the test at decision block 748, the method continues to another continuation terminal (“Terminal C5”). Continuing on to block 750, the method 700 cancels the offer and sends a cancellation request to the drug sample fulfillment platform 608a, 608b. At block 752, the prescription is inhibited from being sent to the pharmacy notwithstanding the fact that other check boxes are checked. For example, the prescription in inhibited from being sent to the pharmacy even if the “send to patient's e-mail” check box is checked. Furthermore, the prescription is inhibited from being sent to the pharmacy even if “send to the patient's mobile” check box is checked.

In another embodiment, the prescription is inhibited from being sent to the pharmacy even if the “one month free voucher” check box is checked. In a further embodiment, the prescription is inhibited from being sent to the pharmacy even if the “apply all patient offers” check box is checked. The method 700 then continues to Terminal C and skips back to block 728 where the above-identified processing steps are repeated. If the answer to the test at decision block 748 is NO, the method 700 proceeds to another decision block 754 where a test is performed to determine whether the script is deleted from the pad. If the answer to the test at decision block 754 is YES, the method 700 proceeds to Terminal C5 and skips back to block 750 where the above-identified processing steps are repeated. Otherwise, the answer to the test at decision block 754 is NO, and the method proceeds to another continuation terminal (“Terminal C6”).

From Terminal C6 (FIG. 7G), the method 700 proceeds to block 756 where the offer is sent via e-mail to the patient and/or his mobile device if the corresponding check boxes are checked. At block 758, if the information is to be sent to a mobile device, the method 700 prepares a message with an embedded URL which is selectable to view the drug sample offer. In one embodiment, the drug sample offer in the portable document format is not displayed in the text to the mobile device; however the URL in the text is selectable to invoke a Web browser to view the drug sample offer. In another embodiment, the drug sample offer is not displayed in the e-mail to the patient but is displayable when the patient selects the URL or the hyperlink to obtain the portable document format document to view the drug sample offer.

At block 760, if the print check box is checked, the offer is sent by the method 700 to a local printer. In one embodiment, the drug sample offer is in the form of a portable document format which is sent to the local printer. At block 762, if the prescriber selects the user interface to process the script pad, the drug sample offer in the form of the prescription and the prescriber notes are sent to the pharmacy for a pharmacist to take action. At block 764, the method sends an offer accepted confirmation to the drug sample fulfillment platform 608a, 608b including the transaction ID and whether it was sent by print, e-mail, or text to a mobile device. The method then continues to exit Terminal D.

From Terminal D (FIG. 7A), the method 700 proceeds to a set of method steps 706 defined between a continuation terminal (“Terminal E”) and an exit terminal (“Terminal F”). The set of method steps 706 facilitates the preparation of the drug sample fulfillment platform 608b for one or more reports regarding one or more requests for drug samples and redemption analytics. From Terminal E (FIG. 7I), the method proceeds to block 782 where the method sends the drug sample fulfillment platform a report indicating data on presented offers and canceled offers. At block 784, the software on the drug sample fulfillment platform collates redemption data from a third-party processor, such as a pharmacy benefits manager, who adjudicates offers, or from the pharma 602. At block 786, the method reports any action regarding the offer (prescription) such as cancellation, completion, printed, texted, e-mailed, and so on. At block 788, the method reports the number of prescribers that received drug sample offers. At block 790, the method reports the number of unique prescribers that saw drug sample offers. At block 792, the method reports the number of drug sample offers seen and/or offered. At block 794, the method 700 reports the number of offers that were printed. At block 796, the method reports the number of prescribers who unchecked the print check box. The method then continues to another continuation terminal (“Terminal E1).

From Terminal E1 (FIG. 7J), the method reports the number of offers sent to pharmacies at block 798. At block 799, the method reports the number of times prescribers unchecked offers (did not accept). At block 797, the method reports the number of times prescribers filled in patients' e-mails to have offers sent to the patients. At block 795, the method reports the number of times prescribers filled in patients' mobile numbers to have the offer texted to the patients. The method then continues to exit Terminal F and terminates execution.

While illustrative embodiments have been illustrated and described, it will be appreciated that various changes can be made therein without departing from the spirit and scope of the invention.

The embodiments of the invention in which an exclusive property or privilege is claimed are defined as follows:

1. A system for electronically distributing drug samples, comprising:
a piece of software implementing an electronic medical record application; and
a drug sample fulfillment platform for providing a list of drug samples from pharmaceutical companies through the electronic medical record application to allow a prescriber to prescribe a drug sample to a patient, the time frame, dosages, and quantity of drug samples being different for different prescribers or different patients depending on brand rules of the pharmaceutical companies.

2. The system of claim 1, wherein drug samples include electronic samples.

3. The system of claim 1, wherein drug samples include electronic vouchers.

4. The system of claim 1, wherein drug samples include electronic coupons.

5. The system of claim 1, wherein instead of the electronic medical record, the piece of software is configured to implement an electronic prescribing application or a mobile application.

6. A method for electronically distributing drug samples, comprising:
receiving a drug sample selection from an electronic medical record application; and
providing a list of drug samples from pharmaceutical companies through the electronic medical record application to allow a prescriber to prescribe a drug sample to a patient, the time frame, dosages, and quantity of drug samples being different for different prescribers or different patients depending on brand rules of the pharmaceutical companies.

7. The method of claim 6, wherein instead of receiving a drug sample selection from an electronic medical record application, the method receives a drug sample selection from an electronic prescribing application or a mobile application.

8. The method of claim 6, further comprising checking eligibility of the patient for the prescribed drug sample by practice zip code, patient's age and gender, prescriber's specialty code, or whether the prescribed drug sample is an initial prescription or a subsequent prescription.

9. The method of claim 8, further forming a drug sample offer in a portable document format and a link to the drug sample offer in the portable document format.

10. The method of claim 9, further sending the drug sample offer to the patient including the link to the drug sample offer in an e-mail to the patient.

11. The method of claim 9, further texting the drug sample offer to the patient including the link to the drug sample offer to a mobile device of the patient.

12. The method of claim 9, further printing the drug sample offer to a local printer.

13. A computer-readable medium on which computer-executable instructions are stored to implement a method for electronically distributing drug samples, comprising:
receiving a drug sample selection from an electronic medical record application; and
providing a list of drug samples from pharmaceutical companies through the electronic medical record application to allow a prescriber to prescribe a drug sample to a patient, the time frame, dosages, and quantity of drug samples being different for different prescribers or different patients depending on brand rules of the pharmaceutical companies.

14. The computer-readable medium of claim 13, wherein instead of receiving a drug sample selection from an electronic medical record application, the method receives a drug sample selection from an electronic prescribing application or a mobile application.

15. The computer-readable medium of claim 13, further comprising checking eligibility of the patient for the prescribed drug sample by practice zip code, patient's age and gender, prescriber's specialty code, or whether the prescribed drug sample is an initial prescription or a subsequent prescription.

16. The computer-readable medium of claim 15, further forming a drug sample offer in a portable document format and a link to the drug sample offer in the portable document format.

17. The computer-readable medium of claim 16, further sending the drug sample offer to the patient including the link to the drug sample offer in an e-mail to the patient.

18. The computer-readable medium of claim 16, further texting the drug sample offer to the patient including the link to the drug sample offer to a mobile device of the patient.

19. The computer-readable medium of claim 16, further printing the drug sample offer to a local printer.
